(19) United States
(12) Patent Application Publication
(10) Pub. No.: US 2012/0031827 A1
(43) Pub. Date: Feb. 9, 2012

(54) AGGLOMERATION OF HIGH SURFACE AREA RARE EARTHS

(75) Inventors: John L. Burba, Parker, CO (US); Carl R. Hassler, Gig Harbor, WA (US); Charles F. Whitehead, Greenwood Village, CO (US); Joseph A. Lupo, Henderson, NV (US); John Lahlouh, San Jose, CA (US); Chris Vogdes, Menlo Park, CA (US); Brandt Wright, Henderson, NV (US)

(73) Assignee: MOLYCORP MINERALS, LLC, Greenwood Village, CO (US)

(21) Appl. No.: 13/205,543

(22) Filed: Aug. 8, 2011

Related U.S. Application Data
(60) Provisional application No. 61/371,567, filed on Aug. 6, 2010.
(60) Provisional application No. 61/393,209, filed on Oct. 14, 2010.
(60) Provisional application No. 61/436,094, filed on Jan. 25, 2011.
(60) Provisional application No. 61/472,499, filed on Apr. 6, 2011.
(60) Provisional application No. 61/475,147, filed on Apr. 13, 2011.

(51) Int. Cl. B01D 39/06; B01J 20/26; B01J 20/28; B01D 15/04; B01D 15/08; B01D 39/20; C02F 1/42; B01J 20/30; B01D 27/02; B82Y 99/00; C02F 101/20

(52) U.S. Cl. 210/198.2; 502/402; 502/5; 502/400; 210/263; 210/287; 210/502.1; 977/773

(57) ABSTRACT

The subject invention relates generally to friable metal oxide agglomerates and specifically to agglomerates containing high surface area rare earth-containing materials and a polymeric binder.

### CROSS REFERENCE TO RELATED APPLICATIONS

The present application claims the benefits of U.S. Provisional Application Ser. Nos. 61/371,567 with a filing date of Aug. 6, 2010 entitled “Agglomeration of High Surface Area Ceria”, 61/393,209 with a filing date of Oct. 14, 2010 entitled “Agglomeration of High Surface Area Ceria”, 61/436,094 with a filing date of Jan. 25, 2011 entitled “Agglomeration of High Surface Area Rare Earths”, 61/472,499 with a filing date of Apr. 6, 2011 entitled “Agglomeration of High Surface Area Rare Earths” and 61/475,147 with a filing date of Apr. 13, 2011, all entitled “Agglomeration of High Surface Area Rare Earths”, each of which is incorporated herein by this reference in their entirety.

### FIELD OF INVENTION

The present invention is related generally to rare earth-containing agglomerates and specifically to rare earth-containing agglomerates containing high surface area cerium-containing materials.

### BACKGROUND OF THE INVENTION

Agglomerating small particles into large particles is well established for dust control, crush resistance, flow control, porosity control, particles having timed-release properties, and other objectives. Particles can be agglomerated under heat and/or pressure, with or without a binding agent. It is generally termed sintering if the material(s) are in powder form and compacted under pressure below the powder melting point.

High strength agglomerates can be produced when a polymeric binder is used to adhere particles together. The polymeric binder can be dissolved in a liquid carrier, suspended in a liquid carrier, or used alone as a pre-polymer or reactive polymeric system. In many cases, the objective is to form a strong, crush resistant agglomerate with a high surface area and a substantially minimum level of binder. In some applications, a specific agglomerate size or agglomerate size distribution is targeted. Polymeric emulsions are a specific subset of polymeric binders for such applications. The polymeric emulsion comprises a liquid polymeric material in the form of particles dispersed in a liquid carrier, the liquid carrier being in the form of a continuous phase. Upon removal of the liquid carrier, the polymeric particles coalesce to form a substantially continuous polymeric film. An attribute of emulsions is the ability to deliver film-forming polymers of a variety of chemistries. Aqueous polymer emulsions are particularly preferred for the ability to form polymer films with only the removal of water.

### SUMMARY OF THE INVENTION

These and other needs are addressed by the various embodiments and configurations of the present invention.

Some embodiments include, a method for making an agglomerate by contacting particles containing a friable metal oxide with a binder emulsion containing a polymeric material to form a cohesive binder mixture and extruding the binder mixture to form metal oxide-containing agglomerates comprising the polymeric material and the particles containing the rare earth oxide. Moreover in some embodiments include contacting friable metal oxide-containing particles with a binder to form a binder mixture and extruding the binder mixture to form metal oxide-containing agglomerates; during extruding, the binder mixture is not heated prior to being forced through a screen or die and/or a binder mixture temperature increases no more than 10 degrees Celsius when passing through the screen or die.

Preferably, the binder mixture has from about 0.1 to about 5 wt % of the polymeric material and from about 50 to 90 wt % of the friable metal oxide with the remainder being water. In some configurations, the binder mixture comprises on a dry basis from about 1 to about 20 wt % of the polymeric material and the remainder being the friable metal oxide-containing particles.

Preferably, the binder mixture is extruded through one of a screen or die into a circulating air stream to form an extrudate. In some embodiments, the circulating air stream has a temperature from about 50 degrees Celsius to about 140 degrees Celsius.

Some embodiments may further include one or more of drying the extrudate at a temperature of no more than about 100 degrees Celsius, cross-linking the polymeric material, and forming the agglomerates by comminuting the extrudate. Preferably, the cross-linking includes one or more of curing at a temperature of from about 20 degrees Celsius to about 200 degrees Celsius, applying ultra-violet energy, applying an electron beam, initiating cross-linking with a cationic initiator, initiating cross-linking with anionic initiator, and initiating cross-linking with a free radical initiator. In some configurations, the drying temperature is from about 5 degrees Celsius and about 130 degrees Celsius and the curing includes heating the extruduate to a temperature of from about 20 degrees Celsius to about 200 degrees Celsius.

Preferably, the friable metal oxide is a rare earth oxide. More preferably, the rare earth oxide is cerium dioxide. In some formulations, the friable metal oxide is in the form of particles, preferably cerium dioxide-containing particles. In some formulations the rare earth oxide particles have: a mean, median, and/or P₉₀ size of about 1 micron or more; a mean and/or median surface area of from about 50 to about 250 m²/g; a mean and/or median pore volume of from about 0.01 to about 0.1 cm³/g; and a mean and/or median pore size of from about 1 to about 10 nm. Moreover in some formulations the rare earth oxide particles have: a mean, median, and/or P₉₀ size of less than about 1 micron; a mean and/or median surface area of from about 5 to about 80 m²/g; a mean and/or median pore volume of from about 0.01 to about 1 cm³/g; and a mean and/or median pore size of from about 5 to about 30 nm.

In some embodiments, the metal oxide-containing agglomerates typically have an aspect ratio of metal oxide-containing agglomerate length to metal oxide-containing agglomerate width (and/or agglomerate diameter) of from about 0.5:1 to about 5:1, and more typically from about 0.5:1 to about 2:1. In some formulations the metal oxide-containing agglomerates comprise from about 0.5 wt % to about 5 wt % of the polymeric material. Preferably, the metal oxide-containing agglomerates have: a mean and/or median pore size from about 1 to about 30 nm; a mean and/or median pore volume size from about 0.01 to about 1 cm³/g; and a mean and/or median surface area of from about 5 to about 250 m²/g. Furthermore in some embodiments, the metal oxide-containing agglomerates have a mean, median and/or mean P₉₀ size of from about 300 to about 500 microns; and the polymeric material comprises a self-crosslinking polyacrylate. In some configurations, the metal oxide-containing agglomerates have a fine content of no more than about 500 NFU.

In some formulations the binder comprises an emulsion, preferably an aqueous emulsion. More preferably, the binder emulsion is an aqueous polyacrylate emulsion. In some embodiments, the binder emulsion comprises from about 35 to about 75 wt % solids. In some configurations, the binder comprises a polymeric material, preferably a substantially C-staged polymeric material. In some embodiments, the binder comprises a thermosetting polymeric material.

Some embodiments include a composition having from about 0.5 to about 10 wt % of a thermosetting polymeric material and from about 90 to about 99.5 wt % of rare earth oxide-containing particles. In some formulations, the thermosetting polymeric material is substantially a C-staged. Preferably, the polymeric material comprises a polyacrylate. The rare earth oxide-containing particles preferably contain a synthetically prepared cerium dioxide. In some formulations the rare earth oxide-containing particles have a mean, median, and/or P₉₀ size of about 1 micron or more, a mean and/or median surface area of from about 50 to about 250 m²/g; a mean and/or median pore volume of from about 0.01 to about 0.1 cm³/g; and a mean and/or median pore size of from about 1 to about 10 nm. In some formulations, the rare earth-containing particles have: a mean, median, and/or P₉₀ size of less than about 1 micron, a mean and/or median surface area of from about 5 to about 80 m²/g; a mean and/or median pore volume of from about 0.01 to about 1 cm³/g; and a mean and/or median pore size of from about 5 to about 30 nm. In some formulations, the composition is in the form of an agglomerate having: an aspect ratio of agglomerate length to agglomerate width of typically about 0.5: to about 5:1, and more typically from about 0.5:1 to about 2:1; a mean and/or median pore size from about 1 to about 30 nm; a mean and/or median pore volume size from about 0.01 to about 1 cm³/g; and a mean and/or median surface area of from about 5 to about 250 m²/g. Preferably the agglomerates have a mean and/or media size form about 300 to about 500 microns. Preferably, the composition has a packing density of from about 1.1 to about 1.7 g/cm³. In some formulations the composition further includes one or more of arsenic, arsenate, arsenite, a biological contaminant, a microbe, a microorganism, a chemical contaminant, a chemical agent, a pharmaceutical, a person care chemical, a pesticide, an insecticide, a herbicide, a rodenticide, a fungicide, humic acid, tannic acid, an oxyanion, a dye, a dye carrier, a dye intermediate, a pigment, a colorant, an ink, a chemical contaminant, or a mixture thereof sorbed on the rare earth oxide-containing particles.

In some embodiments a device for removing contaminants includes the composition. The composition removes one or more contaminants from a fluid treated by the device. The fluid is one of a gas or liquid. Preferably, the fluid is one of air or water. In some embodiments, the device is in the form of one or more of a filter, a filter bed, a filter column, a fluidized filter bed, a filter block, a filter blanket, or combination thereof. In some embodiments, the one or more contaminants comprise arsenic, arsenate, arsenite, a biological contaminant, a microbe, a microorganism, a chemical contaminant, a chemical agent, a pharmaceutical, a person care chemical, a pesticide, an insecticide, a herbicide, a rodenticide, a fungicide, humic acid, tannic acid, an oxyanion, a dye, a dye carrier, a dye intermediate, a pigment, a colorant, an ink, a chemical contaminant, or a mixture thereof.

As used herein, a “friable metal oxide” refers to metal oxide that can be easily reduced to smaller and/or finer particles with little energy input by action from low pressure and/or low friction on the metal oxide particles. Non-limiting examples of friable metal oxides include CeO₂, MgO, SrO, BaO, CaO, TiO₂, ZrO₂, FeO, V₂O₃, V₂O₅, Mn₂O₃, Fe₂O₃, NiO, CuO, Al₂O₃, SiO₂, ZnO, Ag₂O, Mg(OH)₂, Ca(OH)₂, Al(OH)₃, Sr(OH)₂, Ba(OH)₂, Fe(OH)₃, Cu(OH)₃, Ni(OH)₂, Co(OH)₂, Zn(OH)₂, AgOH and mixtures thereof.

As used herein, “absorption” refers to the penetration of one substance into the inner structure of another, as distinguished from adsorption.

As used herein, “adsorption” refers to the adherence of atoms, ions, molecules, polyatomic ions, or other substances of a gas or liquid to the surface of another substance, called the adsorbent. Typically, the attractive force for adsorption can be, for example, ionic forces such as covalent, or electrostatic forces, such as van der Waals and/or London's forces.

As used herein, “sorb” refers to adsorption, absorption or both adsorption and absorption.

As used herein, “comminution” is the process in which solid materials are reduced in size, by crushing, grinding and other techniques.

As used herein, a “composition” refers to one or more chemical units composed of one or more atoms, such as a molecule, polyatomic ion, chemical compound, coordination complex, coordination compound, and the like. As will be appreciated, a composition can be held together by various types of bonds and/or forces, such as covalent bonds, metallic bonds, coordination bonds, ionic bonds, hydrogen bonds, electrostatic forces (e.g., van der Waal's forces and London's forces), and the like.

As used herein “binder” refers to one or more substances that bind together a material being agglomerated. Binders are typically solids, semi-solids, or liquids. Non-limiting examples of binders are polymeric materials, tar, pitch, asphalt, wax, cement water, solutions, dispersions, powders, silicates, gels, oils, alcohols, clays, starch, silicates, acids, molasses, lime and lignosulphonate oils, hydrocarbons, glycerin, stearate, polymers, wax, or combinations thereof. The binder may or may not chemically react with the material being agglomerated. Non-liming examples of chemical reactions include hydration/dehydration, metal ion reactions, precipitation/gelation reactions, and surface charge modification.

The term “emulsion” refers to a mixture of two or more immiscible (that is, unblendable) liquids. Emulsions are a more general class of two-phase systems called colloids. In an emulsion, one or more liquids (the emulsified phase) are dispersed in another liquid (the continuous phase). The emulsified one or more liquids form a dispersed phase within the continuous (another) liquid. The term “suspension” refers to a heterogeneous mixture of a solid, typically in the form of a particulate, dispersed in a liquid (the continuous phase). In a suspension, solid particulates are dispersed in a continuous liquid phase. The term “colloid” refers to a suspension comprising solid particulates that typically do not settle-out from the continuous liquid phase due to gravitational forces. As used hereinafter, the terms “emulsion”, “suspension”, “colloid” or “slurry” will be used interchangeably to refer to one or more materials dispersed and/or suspended in a continuous liquid phase. The one or more dispersed and/or suspended materials may be liquid, solid, or combination of liquid and solid materials.

As used herein, “extrusion” refers to a process to create objects of a substantially fixed cross-sectional profile. A material is pushed or drawn through a die of the desired cross-section. Advantages of extrusion over other manufacturing processes include its ability to work a material generally with compressive and shear stresses. Extrusion may be continuous (theoretically producing an indefinitely long piece) or semi-continuous (producing many pieces). The extrusion process can be done with or without the application of heat to the material, more specifically the extrusion process can be a hot or a cold extrusion process.

The terms “agglomerate” and “aggregate” refer to a composition formed by gathering one or more materials into a mass.

As used herein, “insoluble” refers to materials that are intended to be and/or remain as solids in water and are able to be retained in a device, such as a column, or be readily recovered from a batch reaction using physical means, such as filtration. Insoluble materials should be capable of prolonged exposure to water, over weeks or months, with little loss of mass. Typically, a little loss of mass refers to less than about 5% mass loss of the insoluble material after a prolonged exposure to water.

As used herein, “oxoanion” or “oxoanion” is a chemical compound with the generic formula AₓO_{y}^{z-} (where A represents a chemical element other than oxygen, O represents the element oxygen and x, y and z represent real numbers). In the embodiments having oxyanions as a chemical contaminant, “A” represents metal, metalloid, and/or non-metal elements. Examples for metal-based oxyanions include chromate, tungstate, molybdate, aluminates, zirconate, etc. Examples of metalloid-based oxyanions include arsenate, arsenite, antimonate, germanate, silicate, etc. Examples of non-metal-based oxyanions include phosphate, selemate, sulfate, etc.

As used herein, “precipitation” refers not only to the removal of a contaminant in the form of insoluble species but also to the immobilization of the contaminant on or in the rare earth-containing agglomerate, the rare earth composition, rare earth-containing particle and/or the rare earth comprising the rare earth composition and/or particle. For example, “precipitation” includes processes, such as adsorption and absorption of the contaminate by the rare earth-containing agglomerate, the rare earth composition, rare earth-containing particle and/or the rare earth comprising the rare earth composition and/or particle.

As used herein, “rare earth” refers to one or more of yttrium, scandium, lanthanum, cerium, praseodymium, neodymium, samarium, europium, gadolinium, terbium, dysprosium, holmium erbium, thulium, ytterbium, and lutetium. As will be appreciated, lanthanum, cerium, praseodymium, neodymium, samarium, europium, gadolinium, terbium, dysprosium, holmium erbium, thulium, ytterbium, and lutetium are known as lanthanoids.

As used herein “rare earth-containing composition” and “rare earth-containing particle” refer to any rare earth-containing composition other than non-compositionally altered rare earth-containing minerals. In other words, as used herein “a rare earth-containing composition” and “rare earth-containing particle” exclude comminuted naturally occurring rare earth-containing minerals. However, as used herein “a rare earth-containing composition” and “rare earth-containing particles” include a rare earth-containing mineral where one or both of the chemical composition and chemical structure of the rare earth-containing portion of the mineral has been compositionally altered. More specifically, a comminuted naturally occurring bastnäsite would not be considered a rare earth-containing composition. However, a synthetically prepared bastnäsite or a rare earth-containing composition prepared by a chemical transformation of naturally occurring bastnäsite would be considered a rare earth-containing composition. The rare earth and/or rare-containing composition is, in one application, not a naturally occurring mineral but is synthetically manufactured. Exemplary naturally occurring rare earth-containing minerals include bastnäsite (a carbonate-fluoride mineral) and monazite. Other naturally occurring rare earth-containing minerals include aeschynite, allanite, apatite, britholite, brockite, cerite, fluorcerite, fluorite, gadolinite, parisite, stillwellite, synchisite, titanite, xenotime, zircon, and zirconolite. Exemplary uranium minerals include uraninite (UO₂), pitchblende (a mixed oxide, usually U₃O₈), brannerite (a complex oxide of uranium, rare-earths, iron and titanium), coffinite (uranium silicate), carnotite, autunite, davidite, gummite, torbernite and uranophane. In one formulation, the rare earth-containing composition is substantially free of one or more elements in Group 1, 2, 4-15, or 17 of the Periodic Table, a radioactive species, such as uranium, sulfur, selenium, tellurium, and polonium.

As use herein “a chemical transformation” refers to process where at least some of a material has had its chemical composition transformed by a chemical reaction. “A chemical transformation” differs from “a physical transformation”. A physical transformation refers to a process where the chemical composition has not been chemically transformed but a physical property, such as physical size or shape, has been transformed.

As used herein, “soluble” refers to a material that readily dissolves in liquid, such as water or other solvent. For purposes of this invention, it is anticipated that the dissolution of a soluble material would necessarily occur on a time scale of minutes rather than days. For the material to be considered to be soluble, it is necessary that it has a significantly high solubility in the liquid such that upwards of 5 g/L of the material will dissolve in and be stable in the liquid.

The terminology “removal”, “remove” or “removing” includes the sorption, precipitation, conversion and killing of pathogenic and other microorganisms, such as bacteria, viruses, fungi and protozoa and chemical contaminants. The contaminants may be present in a fluid.

The term “fluid” refers to a liquid, gas or both.

The term “surface area” refers to surface area of a material and/or substance determined by any suitable surface area measurement method. Preferably, the surface area is determined by any suitable Brunauer-Emmett-Teller (BET) analysis technique for determining the specific area of a material and/or substance.

The terms “pore volume” and “pore size”, respectively, refer to pore volume and pore size determinations made by any suite measure method. Preferably, the pore size and pore volume are determined by any suitable Barret-Joyner-Halenda method for determining pore size and volume. Furthermore, it can be appreciated that as used herein pore size and pore diameter can used interchangeably.

As used herein, the term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

These and other advantages will be apparent from the disclosure of the invention(s) contained herein.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below.

### BRIEF DESCRIPTION OF THE DRAWINGS

The accompanying drawings are incorporated into and form a part of the specification to illustrate several examples of the present invention(s). These drawings, together with the description, explain the principles of the invention(s). The drawings simply illustrate preferred and alternative examples of how the invention(s) can be made and used and are not to be construed as limiting the invention(s) to only the illustrated and described examples.

FIG. 1 depicts an embodiment for making agglomerates;

FIG. 2 depicts arsenic (V) removal capacities for agglomerates made by roll compaction and by embodiments according to FIG. 1;

FIG. 3 is a bar graph comparing arsenic (III) removal capacity derived from isotherms data at pH values of pH 6.5, pH 7.5 and pH 8.5;

FIG. 4 depicts a schematic of a testing apparatus for agglomerates;

FIG. 5 depicts a pressure curve obtained from a testing apparatus configured according to FIG. 4;

FIG. 6 depicts a leaching testing procedure for agglomerates and/or agglomeration materials;

FIG. 7 depicts contaminate challenge tests for agglomerates prepared according to various embodiments;

FIG. 8A is a photograph of Direct Blue 15 dye solution prior to addition of ceria;

FIG. 8B is a photograph of a filtrate of the Direct Blue 15 dye solution after the addition of ceria;

FIG. 9A is a photograph of Acid Blue 25 dye solution prior to the addition of ceria;

FIG. 9B is a photograph of a filtrate of the Acid Blue 25 dye solution after the addition of ceria;

FIG. 10A is a photograph of Acid Blue 80 dye solution prior to the addition of ceria;

FIG. 10B is a photograph of a filtrate of the Acid Blue 80 dye solution after the addition of ceria;

FIG. 11A is a photograph of ceria-containing Direct Blue 15 solution 2 minutes after adding ceria to the solution;

FIG. 11B is a photograph of ceria-containing Direct Blue 15 solution 10 minutes after adding ceria to the solution;

FIG. 12A is a photograph of ceria-containing Acid Blue 25 solution 2 minutes after adding ceria to the solution;

FIG. 12B is a photograph of ceria-containing Acid Blue 25 solution 10 minutes after adding ceria to the solution;

FIG. 13A is a photograph of ceria-containing Acid Blue 80 solution 2 minutes after adding ceria to the solution;

FIG. 13B is a photograph of ceria-containing Acid Blue 80 solution 10 minutes after adding ceria to the solution; and

FIG. 14 depicts arsenic removal capacity for agglomerates according to an embodiment.

Further features and advantages will become apparent from the following, more detailed, description of the various embodiments of the invention(s), as illustrated by the drawings referenced below.

### DETAILED DESCRIPTION OF THE INVENTION

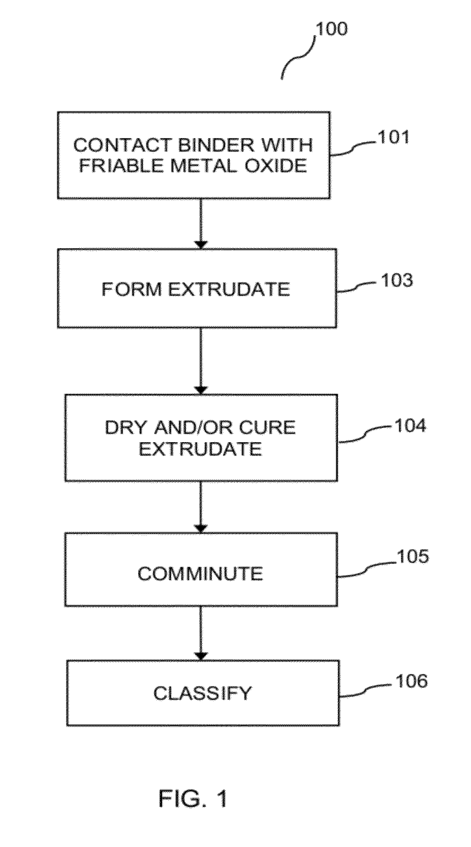

FIG. 1 depicts embodiments of a process 100 for making rare earth-containing agglomerates. The rare earth-containing agglomerates can be in the form of a bead, sphere, box, cylinder, and the like. In step 101, a binder is contacted with rare earth-containing particles to form a binder mixture. Preferably, the binder mixture has a paste-like consistency. In some embodiments, the binder mixture comprises a paste. Preferably, the binder and the rare earth-containing particles are contacted in absence of any applied heat and/or thermal energy.

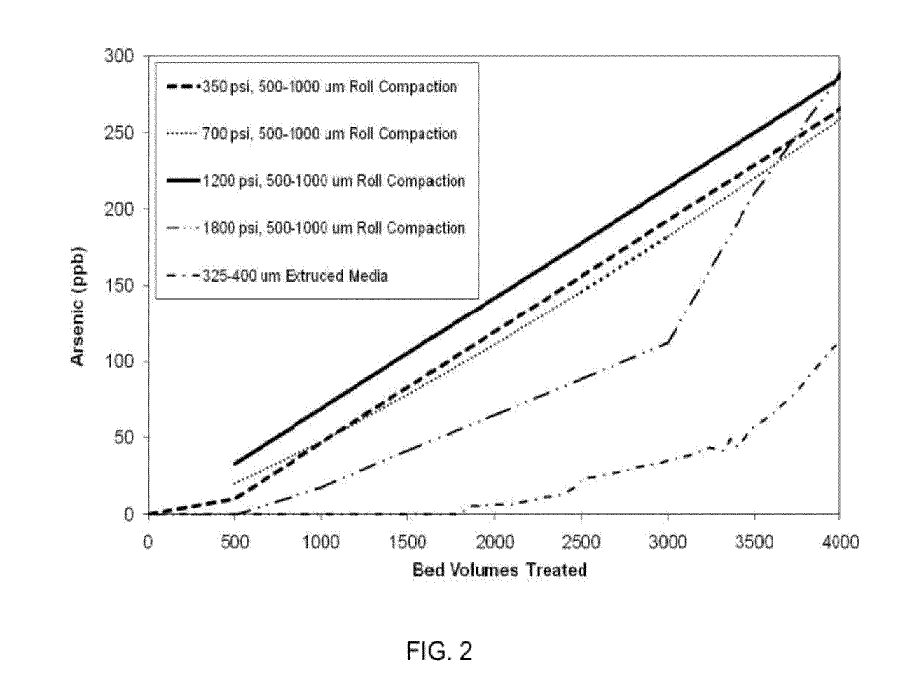

Agglomeration of the rare earth-containing particles with the binder is preferred to roll compaction or other methods of agglomeration. FIG. 2 depicts contaminant removal capacities of rare earth-containing particles agglomerated by roll compaction versus by a binder. The agglomerates formed with binder had a greater removal capacity, arsenic break-through level of 50 ppb arsenic at about 3,500 bed volumes treated, versus arsenic break through levels at about 1,000 to 2,000 bed volumes treated for agglomerates prepared by roll compaction. While not wanting to be limited by any theory, it is believed that the agglomeration with a binder forms agglomerates having one or more of greater surface area, pore volume and/or pore size than agglomerates formed by compaction and/or methods other than with a binder.

The binder can be in the form a binder solution, binder emulsion or combination thereof. The binder can be in the form of an aqueous binder solution, aqueous binder emulsion, or a combination thereof. In some embodiments, the binder has a water continuous phase with a polymeric binder dissolved in the water phase, dispersed and/or suspended in the water phase or a combination thereof.

The binder may comprise one or more polymeric materials. The one or more polymeric materials may include one or more of a homopolymer, copolymer, polymer alloy or a combination thereof, and wherein the polymeric material comprises one or more of vinyl esters, epoxies, polyolefins, polystyrenes, polyvinyls, polyacrylics, polyacrylates, polyhalo-olefins, polydienes, polyoxides, polyesthers, polyacetals, polysulfides, polythioesters, polyamides, polythioamides, polyurethanes, polythiourethanes, polyureas, polythioureas, polyimides, polythioimides, polyanhydrides, polythianhydrides, polycarbonates, polythiocarbonates, polyimines, polysiloxanes, polysilanes, polyphosphazenes, polyketones, polythioketones, polysulfones, polysulfoxides, polysulfonates, polysulfoamides, polyphylenes, fluoropolymers, chloropolymers, and combinations and/or mixtures thereof and where appropriate one or more cross-linking materials. The one or more cross-linking materials may react with one or more of the one or more polymeric materials to form a cross-linked or cured polymeric binder. It can be appreciated that the term polymeric materials refers to one or more polymers alone, that is without a cross-link, or to a mixture containing one or more polymers and one or more cross-links. In some embodiments the binder may comprise an inorganic material, such as, alumina, silica, ammonium silica, or a mixture thereof to name a few.

The one or more polymeric materials may be thermoset and/or thermoplastic polymeric materials or a mixture thereof A thermoplastic polymeric material refers to a material that softens and/or melts when heated and hardens and/or solidifies when cooled. Thermoplastic polymeric materials can be repeatedly softened (when heated) and solidified (when cooled).

A thermoset material refers to a material that can be cross-linked and/or cured. The degree of cross-link and/or cure is typically referred to as one of an A-, B- or C-staged polymeric material. A-stage refers to an early stage of cross-linking and/or curing, where the material can be liquefied or softened when heated and/or is soluble in certain liquids. B-stage refers to an intermediate stage where the polymeric material is not entirely fused (that is, cross-linked and/or cured). A B-staged polymeric material can typically be softened when heated and can swell when contacted with certain liquids. C-stage refers to the final stage of cross-linking and/or curing. A C-staged polymeric material is substantially insoluble and infusible, that is, the polymeric material is substantially incapable of being softened and/or liquefied by heat and is substantially insoluble in certain solvents. Typically, a thermoset polymer is at least one of A-, B- and/or C-staged. More typically, the thermosetting polymer is at least one of A-, B- or C-staged in a cross-linking polymerization process.

In some embodiments, the binder commonly comprises one or both of a polyacrylate and another polymeric material. The other polymeric material may be polystyrene and/or a polyhalo-olefin. The polyhalo-olefin may be a fluoropolymer, polyvinylidene fluoride, polyfluoro-olefin, chloropolymer, polyvinylidene chloride, polychloro-olefin, bromopolymer, polyvinylidene bromide, polybromo-olefine, or combination thereof. The acrylate may comprise acrylate, C₁-acrylates, C₂-acrylates, C₃-acrylates, C₄-acrylates, C₅-acrylates, C₆-acrylates, C₇-acrylates, C₈-acrylates, C₉-acrylates, C₁₀-acrylates, C₁₁-acrylates, C₁₂-acrylates, C₁₃-acrylates, C₁₄-acrylates, C₁₅-acrylates, C₁₆-acrylates, C₁₇-acrylates, C₁₈-acrylates, C₁₉-acrylates, C₂₀-acrylates, esters thereof, or combinations thereof C₁₋₂₀ refers to a hydrocarbon attached to one or both of the vinyl group (that is the CH₂═CH— group of acrylate) and the carboxylate group (that is the —C(═O)CO— group of the acrylate). Furthermore, the C₁₋₂₀ refers to 1-20 carbon atoms interconnected an appropriate number of hydrogen atoms in one or more of acyclic, cyclic, branched, unbranched, olefinic aromatic, or a combination thereof. Moreover, the interconnect C₁₋₂₀ carbon atoms may or may not be interconnected with one of more atoms of oxygen, sulfur, nitrogen, chlorine, fluorine, bromine, and phosphorous. It can be appreciated that metharcrylate can comprise a C₁-acrylate, that ethylacrylate can comprise a C₂-acrylate, and that any one of n-butyl acrylate, isobutyl acrylate and t-butyl acrylate can comprise a C₄-acrylate. In some formulations, the binder can comprise a fluoroethylene alkyl vinyl ether copolymer.

In some embodiments, the binder comprises an acrylate and another polymeric material. The acrylate and the other material are in the form a copolymer. In some formulations the binder further comprises a cross-linker. In some formulations the polymeric materials are self-crosslinking In some formulations, the binder is self-cross-linking, that is the binder comprises the materials to crosslink the polymeric materials, as for example, the polymers, the cross-linker and any necessary other chemical constituents to achieve crosslinking; for example without limitation, a catalyst, activator, or such. Non-limiting examples of acrylate crosslinkers are acetoacetate, amine, anhydride, aziridine, diisocyanate, blocked isocyanates, silane diimide amine, carbodiimide, or combinations thereof.

In some embodiments, the binder comprises a binder emulsion. The binder emulsion commonly has micron-sized particulates comprising the one or more polymeric materials suspended and/or dispersed in a liquid phase. Preferably, the liquid phase comprises water. Commonly, the binder emulsion commonly includes from about 25 to about 75 wt % solids, more commonly from about 30 to about 70 wt % solids, even more commonly from about 35 to about 65 wt % solids, yet even more commonly from about 40 to about 60 wt % solids, and still yet even more commonly from about 40 to 50 wt % solids, with the remainder being the liquid phase, preferably the liquid phase comprises water. In some embodiments the binder emulsion comprises a mixture of two or more emulsions. In one exemplary formulation, the binder emulsion comprises a mixture of two binder emulsions sold under the trade name of AQUATEC 10206™ manufactured by Arkema Inc. and PICASSIAN XL-702™ manufactured by Picassian Polymers. In another exemplary formulation, the binder emulsion comprises an acrylic emulsion sold under the trade name of Hycar 26288™ manufactured by Lubrizol. In yet another exemplary formulation, the binder emulsion comprises a fluoroethylene alkyl vinyl ether copolymer emulsion sold under the trade name of LUMIFLON™ manufactured by Asahi Glass Company.

In some formulations, the binder comprises a food grade binder. Furthermore, in some formulations, the binder when cured is water swellable and/or substantially absorbs water when immersed in an aqueous solution.

In some embodiments, the cured binder may have a glass transition temperature. The glass transition temperature commonly can be from about −20 degrees Celsius to about 100 degrees Celsius, more commonly from about 0 degrees Celsius to about 50 degrees Celsius, and even more commonly from about 10 degrees Celsius to about 40 degrees Celsius. In some formulations, the glass transition temperature for the cured binder is about 20 degree Celsius.

In some embodiments, the binder emulsion has a substantially low viscosity. While not wanting to be limited by theory, it is believed that the substantially low viscosity of the binder emulsion substantially facilitates mixing of the binder with the rare earth-containing particles. Typically, the binder emulsion has a viscosity from about 45 to about 75 cps, more typically from about 50 to about 70 cps, even more typically from about 55-65 cps (as measured on the Brookfield scale, #3 spindle No. 2 at 30 rpm). Preferably, the binder emulsion has a viscosity of about 60 cps (as measured on the Brookfield scale, #3 spindle No. 2 at 30 rpm).

The typical binder mixture comprises from about 0.1 to about 15%, more typically from about 0.2 to about 10%, and even more typically from about 0.5 to about 3% by weight of the one or more polymeric materials and from about 50 to about 90% and more typically from about 70 to about 80% by weight rare earth-containing particles, with the balance being water. Expressed on a solids basis, the binder mixture includes from about 0.1 to about 15%, more typically from about 0.2 to 10%, and even more typically from about 0.1 to about 3.5% by weight of the one or more polymeric materials, with the remainder being the rare earth-containing particles.

In some formulations, the formulations are expressed, respectively, in terms of the volume percent of binder and rare earth-containing particles contacted in step 101. Such formulations are typically, but not always, formulation involving an emulsion and/or liquid binder. The binder volume is the volume of the emulsion and/or liquid binder contacted with a given volume of the rare earth-containing particles. The volume of the rare earth-containing particles is calculated from density of the ceria, that is 7.13 g/cc or its inverse of 0.14 cm³/g. Commonly about 0.5 to about 30 volume % of the binder is contacted with about 95.5 to about 70 volume % of rare earth-containing particles, more commonly from about 2 to about 20 volume % binder is contact with about 98 to about 80 volume % rare earth-containing particles, even more commonly from about 4 to about 15 volume % binder is contacted with about 95 to about 85 volume % rare earth-containing particles, or yet even more commonly from about 8 to about 12 volume % of the binder is contacted with from about 92 to about 88 volume % of the rare earth-containing particles. Preferably, the binder emulsion in such formulations comprises from about 25 to about 75 wt % solids.

The rare earth-containing particles can comprise any rare earth-containing composition. Preferably, the rare earth-containing composition is a synthetically prepared rare earth-containing composition. In some embodiments, the rare earth-containing composition comprises a substantially water insoluble rare earth-containing composition. In some embodiments, the rare earth-containing composition may comprise at least some, if not mostly, a water-soluble rare earth-containing composition. Non-limiting examples of synthetically prepared rare earth-containing compositions are rare earth oxides, chlorides, carbonates, sulfates, nitrates, citrates, silicates, chlorates, perchlorates, phosphate sulfonates, phosphate sulfonate esters, methane sulfonates, triflates (such as, trifluoromethansulfonates salats), oxy chlorides, hydroxides, oxy hydroxides to name a few. Preferably, the rare earth-containing composition comprises one or more rare earths. The rare earths can have an oxidation state of +4, +3 or combination of +4 and +3 oxidation states. In some embodiments, the rare earth-containing composition comprises one or more of cerium, lanthanum, praseodymium, neodymium, samarium or a combination thereof. In other embodiments, the rare earth-containing composition comprises oxides of one or more of cerium, lanthanum, praseodymium, neodymium, samarium or a combination thereof. In yet other embodiments, the rare earth-containing composition comprises cerium oxide. In still yet other embodiments, the rare earth-containing composition comprises CeO₂.

In some embodiments, the rare earth-containing particles have one or more of a mean, median and P₉₀ rare earth particulate size commonly from about 1 to about 1,000 microns, more commonly from about 1 to about 100 microns, even more commonly from about 10 to about 100 microns, even more commonly from about 20 to about 60 microns, and yet even more commonly from about 30 to about 50 microns.

In some embodiments, the one or more of the mean, median and P₉₀ rare earth particulate size is commonly from about 1 to about 100 microns, more commonly from about 3 to about 75 microns, even more commonly from about 5 to about 75 microns, yet even more commonly 5 to 65 microns, still yet even more commonly from about 10 to about 60 microns, or still yet even more commonly from about 15 to about 50 microns.

In some embodiments, the one or more of the mean, median and P₉₀ rare earth particulate size is commonly from about 1 to about 1,000 nanometers, more commonly from about 1 to about 100 nanometers, even more commonly from about 3 to about 75 nanometers, yet even more commonly from about 3 to about 60 nanometers, still yet even more commonly from about 5 to about 50 nanometers and still yet even more commonly from about 20 to about 40 nanometers.

In some embodiments, the rare earth-containing particles have a mean and/or median surface area. The mean and/or median surface area of the rare earth-containing particles is commonly at least about 10 m²/g; more commonly at least about 25 m²/g, even more at least about 35 m²/g, yet even more commonly at least about 50 m²/g, still yet even more commonly at least about 75 m²/g, still yet even more commonly at least about 100 m²/g, still yet even more commonly at least about 110 m²/g, still yet even more commonly at least about 125 m²/g, still yet even more commonly at least about 150 m²/g, still yet even more commonly at least about 200 m²/g or still yet even more commonly at least about 250 m²/g.

In some embodiments, the rare earth containing particles typically have a mean and/or median surface area from about 50 to about 250 m²/g, more typically from about 70 to about 200 m²/g, even more typically from about 80 to about 180 m²/g, and yet even more typically from about 100 to about 150 m²/g. Yet in some embodiments, the rare earth containing particles typically have a mean and/or median surface area from about 5 to about 80 m²/g, more typically from about 10 to about 70 m²/g, even more typically from about 20 to about 60 m²/g, and yet even more typically from about 25 to about 50 m²/g.

In some embodiments, the rare earth containing particles have a moisture content commonly from about 1 to about 15 wt %, more commonly from about 2 to about 10 wt %, even more commonly from about 3 to about 8 wt %. Preferably, the moisture content of the rare earth containing particles is from about 2 to about 12 wt %. The moisture preferably comprises substantially water.

In some embodiments, the rare earth-containing particles have a mean and/or median pore volume. The mean and/or median pore volume of the rare earth-containing particles is typically at least about 0.02 cm³/g, more typically at least about 0.04 cm³/g, even more typically at least about 0.06 cm³/g, yet even more typically at least about 0.08 cm³/g, still yet even more typically at least about 0.1 cm³/g, still yet even more typically at least about 0.2 cm³/g, still yet even more typically at least about 0.3 cm³/g, still yet even more typically at least about 0.5 cm³/g, or still yet even more typically at least about 1 cm³/g.

In some embodiments, the rare earth-containing particles have a mean and/or median pore size and/or diameter (hereinafter referred to as pore size). The mean and/or median pore size commonly can be more than about 1 nm, more commonly more than about 2 nm, even more commonly more than about 3 nm, yet even more commonly more than about 5 nm, still yet even more commonly more than about 8 nm, still yet even more commonly more than about 10 nm, still yet even more commonly more than about 12 nm, still yet even more commonly more than about 14 nm, still yet even more commonly more than about 16 nm, still yet even more commonly more than about 18 nm, still yet even more commonly more than about 20 nm or still yet even more commonly more than about 24 nm.

In some embodiments, the rare earth-containing particles comprise predominantly cerium dioxide. Preferably, the rare earth-containing particles comprise nano-crystalline particles of cerium dioxide. The nano-crystalline particles typically have relatively high surface areas. Commonly, the nano-crystalline particles have a surface area of at least about 10 m²/g, more commonly at least about 50 m²/g, and even more commonly at least about 100 m²/g. The maximum surface area typically is no more than about 250 m²/g, more typically no more than about 175 m²/g, and even more typically no more than about 150 m²/g. In some formulations, particularly with smaller nano-crystalline particles (typically less than 100 nanometer-sized particles), the surface area can be as low as 15 m²/g while still maintaining acceptable performance.

In some embodiments the rare earth-containing particles have a mean, median and/or P₉₀ particle size of about 1 micron or more. Preferably, the rare earth-containing particles having a particle size of about 1 micron or more have a mean and/or median pore size of commonly from about 1 to about 10 nm, more commonly from about 2 to about 8 nm, even more commonly from about 3 to about 7 nm, or yet even more commonly from about 4 to about 6 nm and a mean and/or median volume size of commonly from about 0.01 to about 0.10 cm³/g, more commonly from about 0.02 to about 0.08 cm³/g, even more commonly from about 0.03 to about 0.07 cm³/g, or yet even more commonly from about 0.4 to about 0.06 cm³/g.

Moreover in some embodiments the rare earth-containing particles have a mean, median and/or P₉₀ size from of commonly less than about 1 micron. Preferably, the rare earth-containing particles having a particle size of about 1 micron or less have an agglomerate mean and/or median pore size of commonly from about 5 nm to about 30 nm, more commonly from about 10 nm to about 25 nm, even more commonly from about 16 nm to about 20 nm, or yet even more commonly from about 17 nm to about 19 nm and a mean and/or median volume size of commonly from about 0.01 cm³/g to about 0.9 cm³/g, more commonly from about 0.03 to about 0.7 cm³/g, even more commonly from about 0.05 to about 0.5 cm³/g, or yet even more commonly from about 0.1 to about 0.3 cm³/g.

In some embodiments, the rare earth-containing particles are solid particles having at least one of a median, P₉₀, or mean size commonly of at least about 100 microns, more commonly of at least about 250 microns, more commonly of at least about 500 microns, even more commonly of at least about 750 microns, yet even more commonly of at least about 1 mm, still yet even more commonly of at least about 5 mm, still yet even more commonly of at least about 7.5 mm, and still yet even more commonly of at least about 10 mm. In some embodiment, where the binder comprises particles the rare earth-containing particles and the binder particles can have substantially about the same size. The binder particles can be particles suspended in a binder emulsion or solid powder particles.

Returning to step 101, the rare earth-containing agglomerates preferably comprise the one or more polymeric materials and the rare earth-containing particles. The polymeric materials can be any suitable material, whether a matrix, film, chemical, or lubricant, including, but not limited to, the binders and/or polymers described in US Patent Application Publication No. 2009/0111689, the entire contents of which are incorporated herein by this reference. Suitable polymeric materials include, without limitation, acrylate polymers, styrene polymers, fluoropolymers, bromopolymers, and iodopolymers. In some embodiments, the polymeric material includes one or more of homopolymers, copolymers, polymeric alloys, and mixtures of one or more of polystyrene, polyacrylate, poly(vinylidene fluoride), poly(vinylidene bromide), poly(vinylidene iodide) or mixtures thereof.

Because many rare earths, particularly cerium (IV) oxide, are known oxidants, the polymeric materials preferably should not be substantially oxidizable by the rare earth composition. By way of illustration, polyethylene binders are generally not preferred because cerium dioxide can oxidize polyethylene. More specifically, substantially dry binder mixtures comprising polyethylene and cerium dioxide are generally not preferred. Some formulations containing polyethylene are preferred, when the binder mixture contains substantially enough water, liquid and/or surface active and/or wetting agent to inhibit polyethylene oxidation by the rare earth composition.

Liquid and/or liquid-containing binders typically can provide a desired consistency to the binder mixture. However, when the binder mixture lacks sufficient consistency, water, another liquid and/or material can be added to the binder mixture to provide the desired consistency.

In some instances, the other liquid and/or material can be a surface active and/or wetting agent. While not wanting to be bound by any theory, the surface active and/or wetting agent can one or both improve the consistency of the binder mixture and/or improve the wetting of the rare earth-containing particles by the binder.

The surface active and/or wetting agent can comprise a surfactant, detergent, emulsifier, foaming agent, dispersant or combination thereof. Typically, the surface active and/or wetting agent comprises a hydrophobic group, a hydrophilic group and an optional ionic group. The hydrophobic group may be one or more of a hydrocarbon chain (non-limiting examples include arenes, alkanes, alkenes, cycloalkanes, and alkynes), an alkyl ether chain (non-limiting examples include polyethylene oxides, polypropylene oxides and combinations thereof), a fluorocarbon chain, a siloxane chain, and combinations thereof. The hydrophilic group may be one or more of an anionic group (non-limiting examples include sulfates, sulfonates, phosphates, carboxylates to name a few), an cationic group (non-limiting examples include amines and quaternary ammonium salts to name a few), a zwitter ion (non-limiting examples include primary amines, secondary amines, tertiary amines, or quaternary ammonium cations with one or more of sulfonates, carboxylates and/or phosphates), a non-ionic group (non-limiting examples include alcohols, glycols (examples include without limitation polyoxyethylene, polyoxypropylene, octylphenol ether, and alkylphenol glycols; glycol and glycerol esters), glucosides, sorbitan alkyl esters, and mixtures and combinations thereof (examples of combinations include without limitation polymers, copolymers, block polymers thereof and/or chemical derivatives, such as, esters, amides, oxides, ethers, thereof). The optional ionic group may comprise one or more of monoatomic anions and/or cations (examples include without limitation, alkali metals, alkali earth metals, transition metals, rare earth metals, halogen-containing compounds, chlorine-containing compounds, chloride, bromine-containing compounds, bromide, iodine-containing compounds, iodide, nitrates, sulfates, or combinations thereof), polyatomic ions (examples include without limitation ammonium ions, pyridiniums, triethanolamines, tosyls, trifluoromethanesulfonates, methylsulfates, or combinations thereof) and combinations thereof.

Typically, the relative amounts of the binder and rare earth-containing particles in the binder mixture can depend on the mean, median and/or P₉₀ particle size of the rare earth-containing particles. Rare earth-containing particles, particularly cerium oxides, can be quite friable. The friable rare earth-containing compositions can be damaged and/or reduced in particle size if the polymeric binder and rare earth-containing composition are mixed with too great of a pressure, too vigorously and/or for too long of a time period.

Preferably, step 101 further includes mixing the binder and rare earth-containing particles. The binder and rare earth-containing particles are mixed to form the binder mixture, preferably, a binder mixture having a paste-like consistency. In some embodiments, the binder and rare earth particles can be mixed manually and/or mechanically. The mixing can be with a high, medium or low intensity mixer; a high, medium or low intensity shear mixer; a ribbon blender; or combination thereof. Preferably, a high intensity and/or high shear mixer is used for efficiency and/or scale of the mixing operation. More specifically, high intensity and/or shear mixers are preferred for their speed and efficiency in forming a substantially homogenous binder mixture. Step 101 may further include the binder with the rare earth-containing particles under high shear. While not wanting to be limited by theory, it is believed that the high shear can control the particle size of the binder during the contacting of the binder with the rare earth-containing particles. Preferably, the mixing comprises a stirring and/or kneading operation. While not wanting to be limited by example, low shear typically refers to mixing at no more than about 0.1 sec⁻¹ and high shear typically refers to mixing at about 1,000 sec⁻¹ or more. In some embodiments, high shear mixing can commonly be as low as about 10 sec⁻¹, more commonly as low as about 50 sec⁻¹, even more commonly as low as about 100 sec⁻¹, or yet even as low as about 500 sec⁻¹.

The mixing can be done by any of a number of methods capable of mixing intimately the rare earth-containing particles with the binder. Preferably, the mixing is preformed at ambient temperature. More preferably, the mixing is preformed without applying heat and/or thermal energy to the binder mixture during mixing.

The mixing is performed for a sufficient time and intensity to provide intimate contacting and mixing of the rare earth-containing particles and binders. Preferably, the mixing is preformed for a sufficient time period and intensity to substantially wet at least most, if not, all of the rare earth-containing particles with the binder. While not wanting to bound by any theory, it is believed that if the rare earth-containing particles are not sufficiently wetted with the binder, the binder mixture will be inhomogenous and/or non-cohesive.

Preferably, the binder mixture should have enough cohesion to form a paste-like bundle. That is, the binder mixture should not be in the form of one or more of a dry crumble, a sticky, viscous mass and/or a bundle substantially lacking cohesive. Preferably, the binder mixture should have sufficient cohesion to feed a low-pressure extruder.

Preferably, the paste-like bundle of the binder mixture is substantially self-supporting and has sufficient cohesion. More preferably, the paste-like bundle has sufficient cohesion to maintain its cohesion when deformed, such as by manually kneading the bundle. More specifically, the paste-like bundle commonly can be deformed and maintain its cohesive form when a pressure of no more than about 1,000 psi is applied, more common when a pressure of no more than about 750 psi is applied, even more commonly when a pressure of no more than about 500 psi is applied, yet even more commonly when a pressure of no more than about 250 psi is applied, still yet more commonly when a pressure of no more than about 150 psi is applied, still yet more commonly when a pressure of no more than about 100 psi is applied, still yet more commonly when a pressure of no more than about 90 psi is applied, still yet more commonly when a pressure of no more than about 80 psi is applied, still yet more commonly when a pressure of no more than about 70 psi is applied, still yet more commonly when a pressure of no more than about 60 psi is applied, still yet more commonly when a pressure of no more than about 50 psi is applied, still yet more commonly when a pressure of no more than about 40 psi is applied, still yet more commonly when a pressure of no more than about 30 psi is applied, still yet more commonly when a pressure of no more than about 20 psi is applied, or still yet more commonly when a pressure of no more than about 10 psi is applied.

In some formulations where the binder and rare earth-containing particles are both dry powders, a liquid, such as but not limited to water and/or a surface active and/or wetting agent, can be added to sufficiently wet and/or sufficiently adhere the binder to the rare earth-containing particles.

In some embodiments, the contacting and mixing portions of step 101 can be performed in one or more stages, such as a multi-stage cyclic process. A multi-stage cyclic process refers to the contacting and mixing portions of step 101 being repeated, sequentially and/or combinedly, two or more times. Non-limiting examples of multi-stage cyclic processes follow. By way of a first non-limiting example, the binder mixture is contacted with a first portion of the rare earth-containing particles and after mixing the first portion of the rare earth-containing particle with the binder the remaining portion or portions of the rare earth-containing particles is/are contacted with the binder and mixed to form the binder mixture. By way of a second non-limiting example, the rare earth-containing particles are contacted with a first portion of the binder and after mixing the rare earth-containing particles with the first portion of the binder, the remaining portion or portions of the binder is/are contacted with the rare earth-containing particles and mixed to form the binder mixture. By way of a third non-limiting example, a first portion of one or both of the binder and the rare earth-containing particles are contacted and mixed before one or both of a second portion(s) of one or both of the binder and the rare earth-containing particles are contacted and mixed to form the binder mixture.

In step 103, an extrudate is formed. Extruding the binder mixture through an extrusion screen or die under an applied pressure forms the extrudate. Preferably, an extruder applies the pressure that forces the binder mixture through the extrusion screen or die. While not wanting to limited by example, the extruder can be a single or multiple screws, an auger, direct, indirect, hydrostatic, a basket, single dome, twin dome, and/or radial extruder. Preferably, the extruder is one of a basket, single dome, twin dome or radial extruder.

Preferably, the extrusion process is a low-pressure extrusion process. Low-pressure extruders typically form the extrudate by pushing, scraping, and/or mechanically applying pressure to the binder mixture to force the binder mixture through the extrusion screen or die. In some other embodiments, medium pressure extruders, such as a radial extruder, can be used and yet other embodiments high-pressure extruders, such as hydraulic and piston presses and compactors, can be used. High-pressure extrusion is commonly not desired due to the friability of the rare earth at the pressures typically encountered during high-pressure extrusion. The extrudate is formed by a wet extrusion process when the binder comprises an emulsion and/or solution.

The extrusion process may be performed at any suitable temperature, such as by hot, warm or cold extrusion techniques. Preferably in some embodiments, the extrusion temperature is below the melting temperature of the rare earth-containing particles and optionally the polymeric materials. Moreover, the extrusion temperature is preferably below the degradation temperature of the polymeric material(s).

Preferably, the extrusion process is preformed at ambient temperature. More preferably, the extrusion process is preformed without applying heat and/or thermal energy to the binder mixture prior to and/or during the extrusion process.

Furthermore in some embodiments, the process of extruding the binder mixture through the extrusion screen and/or die imparts little, if any, thermal energy to the binder mixture. More specifically, the little, if any, thermal energy imparted to binder mixture when extruding the binder mixture through the extrusion screen and/or die commonly does not increase in temperature of the binder mixture, more commonly increases the binder mixture temperature no more than about 0.5 degrees Celsius, even more commonly increases the binder mixture temperature no more than about 1 degree Celsius, yet even more commonly increases the binder mixture temperature no more than about 2 degrees Celsius, still yet even more commonly increased the binder mixture temperature no more than about 5 degrees Celsius, still yet even more commonly increased the binder mixture temperature no more than about 10 degrees Celsius, still yet even more commonly increased the binder mixture temperature no more than about 15 degrees Celsius, still yet even more commonly increased the binder mixture temperature no more than about 20 degrees Celsius, still yet even more commonly increased the binder mixture temperature no more than about 25 degrees Celsius, still yet even more commonly increased the binder mixture temperature no more than about 30 degrees Celsius, or still yet even more commonly increased the binder mixture temperature no more than about 35 degrees Celsius.

While not wanting to be limited by theory, it is believed that binder mixture consistency, as modified by one or more of water, fluid, and/or surface active and/or wetting agents, can affect extrusion temperature and/or thermal energy imparted to the binder mixture during the extrusion process. More particularly, the thermal energy imparted to the binder mixture and/or extrusion temperature is typically lower for binder mixtures having a greater level of water, fluid and/or surface active and/or wetting agents than for binder mixtures substantially lacking and/or having a lesser level of water, fluid and/or surface active and/or wetting agents.

The extrusion process can be a low-, medium- or high-pressure extrusion process. Preferably, the extrusion process is a low-pressure extrusion process. Commonly, the extrusion pressure is no more than about 1,000 psi, more common the extrusion pressure is no more than about 750 psi, even more commonly the extrusion pressure is no more than about 500 psi, yet even more commonly the extrusion pressure is no more than about 250 psi, still yet more commonly the extrusion pressure is no more than about 150 psi, still yet more commonly the extrusion pressure is no more than about 100 psi, still yet more commonly the extrusion pressure is no more than about 90 psi, still yet more commonly the extrusion pressure is no more than about 80 psi, still yet more commonly the extrusion pressure is no more than about 70 psi, still yet more commonly the extrusion pressure is no more than about 60 psi, still yet more commonly the extrusion pressure is no more than about 50 psi, still yet more commonly the extrusion pressure is no more than about 40 psi, still yet more commonly the extrusion pressure is no more than about 30 psi, still yet more commonly the extrusion pressure is no more than about 20 psi, or still yet more commonly the extrusion pressure is no more than about 10 psi. The extrusion pressure refers to the pressure being applied to the binder mixture to force the binder mixture through the extrusion screen and/or die. It can be appreciated that while the extrusion process has been described in terms of psi, the extrusion process for many extruders is controlled and/or operated in terms of amperage, torque, and/or other physical and/or mechanical operating parameter of the extruder. It can be further appreciated that, the extrusion pressure refers to the pressure that the binder mixture, preferably the binder mixture in form of a paste-like cohesive bundle, can be pushed through the extrusion screen and/or die aperture at. In some embodiments, the extrusion pressure refers to minimum pressure that the binder mixture can be forced through the extrusion screen and/or die.

While not wanting to be limited by theory, the low-pressure extrusion process substantially reduces and/or minimizes damage to the rare earth-containing particles during extrusion. More specifically, the low-pressure extrusion process substantially reduces damage to friable rare earth-containing particles, such as, but not limited to cerium dioxide, during extrusion of the binder mixture.

In some embodiments, the binder mixture consistency and/or viscosity are one or both of monitored and controlled to support a low-pressure extrusion process. Typically the binder mixture fluid content is monitored during the extrusion process. The binder mixture fluid content consistency and/or viscosity can be adjusted and/or controlled by adjusting the fluid content of the binder mixture.

The extrudate can have any geometric form. In some embodiments, the extrudate is in the form of an extruded strand. The extruded strand can have, by way of non-limiting example, a circular, rhombic, square, rectangular, elliptical, or trilobal shaped cross-section. Preferably, the extrudate has a cross-sectional shape substantially resembling one of circle, square, rectangle, ellipse, or rhombus.

The extrudate can be formed in any length. Commonly, the extrudate has a length of greater than about 0.5 mm, more commonly greater than about 1 mm, even more commonly greater than about 2 mm, or yet even more commonly greater than about 10 mm. More commonly the extrudate has a length greater than about 1 cm, even more commonly greater than about 5 cm, yet even more commonly greater than about 10 cm, and still yet even more commonly greater than about 15 cm.

In some embodiments, the extrusion screen or die comprises a plurality of apertures. The binder mixture is contacted with the extrusion screen under a pressure applied by the extruder. The applied pressure is at least substantially sufficient to push the binder mixture through the plurality of apertures to form the extrudate. It can be appreciated that extruding the binder mixture through the plurality of apertures forms a plurality of extruded strands.

The plurality of apertures has an aperture width. In some embodiments, the aperture width is one of from commonly about 10 microns, from more commonly about 30 microns, from yet more commonly about 50 microns, from still yet even more commonly about 75 microns, from still yet even more commonly about 85 microns, from still yet even more commonly about 100 microns, from still yet even more commonly about 125 microns, from still yet even more commonly about 150 microns, from still yet even more commonly about 175 microns, from still yet even more commonly about 200 microns, from still yet even more commonly about 225 microns, from still yet even more commonly about 250 microns, from still yet even more commonly about 275 microns, from still yet even more commonly about 300 microns, from still yet even more commonly about 350 microns, from still yet even more commonly about 400 microns, from still yet even more commonly about 450 microns, from still yet even more commonly about 500 microns, or from still yet even more is commonly about 550 microns to one of commonly about 40 microns, more commonly about 60 microns, yet more commonly about 80 microns, still yet even more commonly about 100 microns, still yet even more commonly about 150 microns, still yet even more commonly about 200 microns, still yet even more commonly about 250 microns, still yet even more commonly about 300 microns, still yet even more commonly about 350 microns, still yet even more commonly about 400 microns, still yet even more commonly about 450 microns, still yet even more commonly about 500 microns, still yet even more commonly about 550 microns, still yet even more commonly about 600 microns, still yet even more commonly about 650 microns, still yet even more commonly about 700 microns, still yet even more commonly about 800 microns, still yet even more commonly about 900 microns, or still yet even more is commonly about 1,000 microns.

In some embodiments, the aperture width substantially corresponds to a mesh screen size of typically about Tyler mesh screen size 9, more typically about Tyler mesh screen size 10, even more typically about Tyler mesh screen size 12, yet even more typically about Tyler mesh screen size 14, still yet even more typically about Tyler mesh screen size 16, still yet even more typically about Tyler mesh screen size 20, still yet even more typically about Tyler mesh screen size 24, still yet even more typically about Tyler mesh screen size 28, still yet even more typically about Tyler mesh screen size 32, still yet even more typically about Tyler mesh screen size 35, still yet even more typically about Tyler mesh screen size 42, still yet even more typically about Tyler mesh screen size 48, still yet even more typically about Tyler mesh screen size 60, still yet even more typically about Tyler mesh screen size 65, still yet even more typically about Tyler mesh screen size 80, still yet even more typically about Tyler mesh screen size 100, still yet even more typically about Tyler mesh screen size 115, or still yet even more typically about Tyler mesh screen size 150.

Step 104 may optionally include extruding the strands into a heated environment having a temperature of commonly from about 10 degrees Celsius, more commonly from about 15 degrees Celsius, yet more commonly from about 20 degrees Celsius, still yet more commonly from about 25 degrees Celsius, still yet more commonly from about 30 degrees Celsius, still yet more commonly from about 35 degrees Celsius, still yet more commonly from about 40 degrees Celsius, still yet more commonly from about 50 degrees Celsius, still yet more commonly from about 55 degrees Celsius, still yet more commonly from about 60 degrees Celsius, still yet more commonly from about 70 degrees Celsius, still yet more commonly from about 80 degrees Celsius or still yet more commonly from about 90 degrees Celsius to one of commonly about 20 degrees Celsius, even more commonly about 25 degrees Celsius, yet even more commonly about 30 degrees Celsius, still yet even more commonly about 35 degrees Celsius, still yet even more commonly about 40 degrees Celsius, still yet even more commonly about 50 degrees Celsius, still yet even more commonly about 55 degrees Celsius, still yet more commonly from about 60 degrees Celsius, still yet more commonly from about 70 degrees Celsius, still yet more commonly from about 80 degrees Celsius, still yet more commonly from about 90 degrees Celsius or still yet even more commonly about 100 degrees Celsius.

The temperature of the heated environment is preferably sufficient to substantially keep the extruded strands from sticking together. Typically, the temperature is from about 30 to about 90 degrees Celsius, more typically from about 40 to about 80 degrees Celsius, and even more typically from about 50 to about 60 degrees Celsius. Preferably, the temperature is not too high such that the extruded strands lose their moisture too rapidly. When moisture lost is too rapid it becomes more difficult to form strands by extrusion.

In some embodiments, the heated environment is heated air. The heated air may or may not be circulating heated air. It can be appreciated that the heated environment can assist in one or both of curing the one or more polymeric materials and/or drying the extrudate when the binder mixture comprises at least one of a solution liquid, emulsion, water or a combination thereof.

It can be appreciated that in some embodiments, monitoring and controlling the relative humidity of the heated environment can control the rate and level of water removal from the extruded strands. The rate and amount of water removal from the extruded strands can affect one or both of strand strength and/or porosity. While not wanting to be limited by theory, it is believed that water removal, particularly controlled water removal, opens fluid flow pathways in the strand, and ultimately fluid flow in pathways the rare earth-containing agglomerates. Furthermore, it is believed that controlling water removal during the drying step can provide dried strands, and ultimately rare earth-containing agglomerates, with one or more of higher porosities, pore volumes, and/or pore sizes. While not wanting to limited by theory, it is believed that one or more of the fluid pathway, porosities, pore size, and/or pore volume are significant contributors to one or both of contaminant removal by the rare earth-containing agglomerate and efficiency in treating large volumes of contaminant-containing fluid rapidly.

In some embodiments, the heated environment can be monitored and/or maintained to a relative humidity of typically no more than about 100%, more typically no more than about 95%, even more typically no more than about 90%, yet even more typically no more than about 80%, still yet even more typically no more than about 70%, still yet even more typically no more than about 60%, still yet even more typically no more than about 50%, still yet even more typically no more than about 40%, still yet even more typically no more than about 30%, still yet even more typically no more than about 20%, still yet even more typically no more than about 10%, or still yet even more typically no more than about 2%.

In step 104, the extruded strands are dried at a drying temperature to form dried extruded strands. The drying of the strands can be preformed by any drying method that achieves heating the extruded strands to about the drying temperature. While not wanting to be limited by example, suitable drying methods include radiant heating, infrared heating, microwave heating, heating achieved by circulating a hot fluid, and/or heating in an oven (non-limiting examples of suitable ovens include static, conveying or convention), fixed or fluidized bed, or tube, to name a few.

Following drying, commonly at least most, more commonly at least about 75%, and even more commonly at least about 95% of the liquid phase (such as, but not limited to water) is removed. The final fluid and/or water content of the dried extrudated strands is commonly no more than about 10 wt %, even more commonly no more than about 8 wt %, yet even more commonly no more than about 6 wt %, still yet even more commonly no more than about 5 wt %, still yet even more commonly no more than about 4 wt %, still yet even more commonly no more than about 3 wt %, still yet even more commonly no more than about 2 wt %, or still yet even more commonly no more than about 1 wt %.

The drying temperature is typically no more than about 260 degrees Fahrenheit (or about 130 degrees Celsius), more typically no more than about 250 degrees Fahrenheit (or about 120 degrees Celsius), even more typically no more than about 240 degrees Fahrenheit (or about 115 degrees Celsius), yet even more typically no more than about 230 degrees Fahrenheit (or about 110 degrees Celsius), still yet even more typically no more than about 220 degrees Fahrenheit (or about 105 degrees Celsius), still yet even more typically no more than about 210 degrees Fahrenheit (or about 100 degrees Celsius), still yet even more typically no more than about 200 degrees Fahrenheit (or about 95 degrees Celsius), still yet even more typically no more than about 190 degrees Fahrenheit (or about 90 degrees Celsius), still yet even more commonly no more than about 180 degrees Fahrenheit (or about 80 degrees Celsius), still yet even more commonly no more than about 170 degrees Fahrenheit (or about 75 degrees Celsius), still yet even more commonly no more than about 160 degrees Fahrenheit (or about 70 degrees Celsius), still yet even more commonly no more than about 150 degrees Fahrenheit (or about 65 degrees Celsius), still yet even more commonly no more than about 140 degrees Fahrenheit (or about 60 degrees Celsius), still yet even more commonly no more than about 130 degrees Fahrenheit (or about 55 degrees Celsius), still yet even more commonly no more than about 120 degrees Fahrenheit (or about 50 degrees Celsius), still yet even more commonly no more than about 110 degrees Fahrenheit (or about 40 degrees Celsius), still yet even more commonly no more than about 100 degrees Fahrenheit (or about 35 degrees Celsius), still yet even more commonly no more than about 90 degrees Fahrenheit (or about 30 degrees Celsius), still yet even more commonly no more than about 80 degrees Fahrenheit (or about 25 degrees Celsius), or still yet even more commonly no more than about 70 degrees Fahrenheit (or about 20 degrees Celsius), still yet even more commonly no more than about 60 degrees Fahrenheit (or about 15 degrees Celsius), or still yet even more commonly no more than about 50 degrees Fahrenheit (or about 10 degrees Celsius).

In some embodiments, the extruded strands are dried at the drying temperature for a period of time commonly no more than about 48 hours, more commonly no more than about 36 hours, even more commonly no more than about 24 hours, yet even more commonly no more than about 18 hours, still yet even more commonly no more than about 16 hours, still yet even more commonly no more than about 12 hours, still yet even more commonly no more than about 10 hours, still yet even more commonly no more than about 8 hours, still yet even more commonly no more than about 6 hours, still yet even more commonly no more than about 4 hours, still yet even more commonly no more than about 3 hours, still yet even more commonly no more than about 2 hours, or still yet even more commonly no more than about 1 hour. In some configurations, the extruded strands may be dried for more than 48 hours.

Step 104 may optionally include curing and/or cross-linking the polymeric material comprising the extruded and/or dried extruded strands at a curing temperature to form cured strands. The curing of the strands can be conducted by any curing method that substantially cures the material. While not wanting to be limited by example, suitable curing methods include heating the strands to a curing temperature, exposing the strands to ultra-violet energy, exposing the strands to an electron beam, reacting the polymeric material with acationic initiator, anionic initiator, free radical initiator, or any other method that induces and/or activates cross linking of the polymer material. It can be appreciated that suitable methods for heating the strands to the curing temperature include, without limitation radiant heating, infrared heating, microwave heating, heating achieved by circulating a hot fluid, and/or heating in an oven (non-limiting examples of suitable ovens include static, conveying or convention), fixed or fluidized bed, or tube, to name a few. In some embodiments, the polymeric material is at least substantially mostly B-staged. In some embodiments, the polymeric material is at least substantially mostly, if not substantially completely, C-staged.

The curing temperature is commonly, but not necessarily, greater than the drying temperature. The curing temperature is commonly more than about 50 degrees Fahrenheit (or about 10 degrees Celsius), more commonly more than about 60 degrees Fahrenheit (or about 15 degrees Celsius), even more commonly more than about 70 degrees Fahrenheit (or about 20 degrees Celsius), yet even more commonly more than about 80 degrees Fahrenheit (or about 25 degrees Celsius), still yet even more commonly more than about 90 degrees Fahrenheit (or about 30 degrees Celsius), still yet even more commonly more than about 100 degrees Fahrenheit (or about 35 degrees Celsius), still yet even more commonly more than about 110 degrees Fahrenheit (or about 40 degrees Celsius), still yet even more commonly more than about 120 degrees Fahrenheit (or about 50 degrees Celsius), still yet even more commonly more than about 130 degrees Fahrenheit (or about 55 degrees Celsius), still yet even more commonly more than about 140 degrees Fahrenheit (or about 60 degrees Celsius), still yet even more commonly more than about 150 degrees Fahrenheit (or about 65 degrees Celsius), still yet even more commonly more than about 160 degrees Fahrenheit (or about 70 degrees Celsius), still yet even more commonly more than about 170 degrees Fahrenheit (or about 75 degrees Celsius), still yet even more commonly more than about 180 degrees Fahrenheit, still yet even more commonly more than about 190 degrees Fahrenheit (or about 90 degrees Celsius), still yet even more commonly more than about 200 degrees Fahrenheit (or about 95 degrees Celsius), still yet even more commonly more than about 210 degrees Fahrenheit (or about 100 degrees Celsius), still yet even more commonly more than about 220 degrees Fahrenheit (or about 105 degrees Celsius), still yet even more commonly more than about 230 degrees Fahrenheit (or about 110 degrees Celsius), still yet even more commonly more than about 240 degrees Fahrenheit (or about 115 degrees Celsius), still yet even more commonly more than about 250 degrees Fahrenheit (or about 120 degrees Celsius), still yet even more commonly more than about 260 degrees Fahrenheit (or about 130 degrees Celsius), still yet even more commonly more than about 270 degrees Fahrenheit (or about 135 degrees Celsius), still yet even more commonly more than about 280 degrees Fahrenheit (or about 140 degrees Celsius), still yet even more commonly more than about 290 degrees Fahrenheit (or about 145 degrees Celsius), still yet even more commonly more than about 300 degrees Fahrenheit (or about 150 degrees Celsius), still yet even more commonly more than about 310 degrees Fahrenheit (or about 155 degrees Celsius), still yet even more commonly more than about 320 degrees Fahrenheit (or about 160 degrees Celsius), still yet even more commonly more than about 330 degrees Fahrenheit (or about 165 degrees Celsius), still yet even more commonly more than about 340 degrees Fahrenheit (or about 170 degrees Celsius) or still yet even more commonly more than about 350 degrees Fahrenheit (or about 180 degrees Celsius). Preferably, the cure temperature is typically one of about 100 degrees Celsius, more typically about 110 degrees Celsius, even more typically about 120 degrees Celsius, yet even more typically about 130 degrees Celsius, still yet even more typically about 140 degrees Celsius, still yet even more typically about 150 degrees Celsius, still yet even more typically about 160 degree Celsius, or yet still even more typically about 170 degrees Celsius.

In some embodiments, the strands are cured at the curing temperature for a period of time commonly of no more than about 48 hours, more commonly of no more than about 36 hours, even more commonly of no more than about 24 hours, yet even more commonly of no more than about 18 hours, still yet even more commonly of no more than about 16 hours, still yet even more commonly of no more than about 12 hours, still yet even more commonly of no more than about 10 hours, still yet even more commonly of no more than about 8 hours, still yet even more commonly of no more than about 6 hours, still yet even more commonly of no more than about 4 hours, still yet even more commonly of no more than about 3 hours, still yet even more commonly of no more than about 2 hours, or still yet even more commonly of no more than about 1 hour.

Preferably, one or both of the drying and curing temperatures are below the degradation temperature of the one or more polymeric materials. Commonly, the drying temperature is no more than about 100 degrees Celsius or about 210 degrees Fahrenheit. The curing temperature is commonly from about 100 (or about 210 degrees Fahrenheit) to about 250 degrees Celsius (or about 480 degrees Fahrenheit).

In some embodiments, the drying and curing steps may be combined and performed in the same operation and/or with the same piece of heating equipment. For example, the drying and curing steps can be performed in the same piece of heating equipment by ramping the temperature from the drying temperature to the curing temperature.

In step 105, the dried and/or cured strands are comminuted to form comminuted-strands and fines. The comminuting of dried and/or cured strands may be conducted by any suitable comminution process and/or method. Non-limiting examples of suitable comminuting processes and/or methods include shaking, grinding, pulverizing, rubbing, crushing, breaking, or such of the dried and/or cured strands. Preferably in some embodiments, the comminuting process comprises breaking the dried and/or cured strands by vibration or by use of an attrition media, such as nylon brushes or ceramic balls, during the comminuting process. In some embodiments, the comminuting process includes a comminuting screen containing apertures.

Preferably, the comminuting process is preformed to produced at least some comminuted-strands commonly having a comminuted strand length to comminuted strand width ratio typically from about 0.5:1 to about 5:1, or more typically from about 0.5:1 to about 2:1 or more commonly the comminuted strand length to comminuted strand width ratio is about 1:1. More preferably, the comminuting process is preformed to produced at least most comminuted-strands typically having a comminuted strand length to comminuted strand width ratio from about 0.5:1 to about 2:1 or more typically the comminuted strand length to comminuted strand width ratio is about 1:1.

In some embodiments, the comminuting screen has apertures that retain at least most of the comminuted strand having a comminuted strand length to comminuted strand width ratio typically from about 0.5:1 to about 5:1, or more typically from about 0.5:1 to about 2:1 and pass at least most of the comminuted strands having a comminuted strand length to comminuted strand width ratios substantially smaller than the range typically from about 0.5:1 to about 5:1, or more typically from about 0.5:1 to about 2:1. Preferably, the comminuting screen has apertures that retain at least most of the comminuted strand having a comminuted strand length to comminuted strand width ratio of about 1:1 and pass at least most of the comminuted strands having a comminuted strand length to comminuted strand width ratio substantially smaller than about 1:1.

In some embodiments, the community screen apertures have one of a size typically from about 100 microns, a size more typically from about 150 microns, a size even more typically from about 200 microns, a size yet even more typically from about 250 microns, a size still yet even more typically from about 300 microns, a size still yet even more typically from about 350 microns, a size still yet even more typically from about 400 microns, a size still yet even more typically from about 450 microns, a size still yet even more typically from about 500 microns, a size still yet even more typically from about 550 microns, a size still yet even more typically from about 600 microns, a size still yet even more typically from about 650 microns, a size still yet even more typically from about 700 microns, a size still yet even more typically from about 750 microns, a size still yet even more typically from about 800 microns, a size still yet even more typically from about 850 microns, a size still yet even more typically from about 900 microns, a size still yet even more typically from about 950 microns, a size still yet even more typically from about 1,000 microns, or a size still yet even more typically from about 1,100 microns to one of typically about 200 microns, more typically about 250 microns, even more typically about 300 microns, yet even more typically about 350 microns, still yet even more typically about 400 microns, still yet even more typically about 450 microns, still yet even more typically about 500 microns, still yet even more typically about 550 microns, still yet even more typically about 600 microns, still yet even more typically about 650 microns, still yet even more typically about 700 microns, still yet even more typically about 750 microns, still yet even more typically about 800 microns, still yet even more typically about 850 microns, still yet even more typically about 900 microns, still yet even more typically about 950 microns, still yet even more typically about 1,000 microns, still yet even more typically about 1,100 microns or still yet even more typically about 1,200 microns.

In some embodiments, the comminuting screen apertures substantially correspond to a screen size of typically about Tyler mesh screen size 10, more typically about Tyler mesh screen size 12, even more typically about Tyler mesh screen size 14, yet even more typically about Tyler mesh screen size 16, still yet even more typically about Tyler mesh screen size 20, still yet even more typically about Tyler mesh screen size 24, still yet even more typically about Tyler mesh screen size 28, still yet even more typically about Tyler mesh screen size 32, still yet even more typically about Tyler mesh screen size 35, still yet even more typically about Tyler mesh screen size 42, still yet even more typically about Tyler mesh screen size 48, still yet even more typically about Tyler mesh screen size 60, still yet even more typically about Tyler mesh screen size 65, still yet even more typically about Tyler mesh screen size 80, still yet even more typically about Tyler mesh screen size 100, still yet even more typically about Tyler mesh screen size 115, still yet even more typically about Tyler mesh screen size 150, still yet even more typically about Tyler mesh screen size 170 or still yet even more typically about Tyler mesh screen size 200.

In step 105, the comminuted-strands may be classified according to size to form filter media strands (also referred to herein as the rare earth-containing agglomerate) and a plurality of other strands. The comminuted-strands can be classified by any size classification method, such as, but not limited to screens, gravity, floatation, or cyclones. Preferably, the size classification method provides rare earth-containing agglomerates having the desired size distribution.

It can be appreciated that rare earth-containing agglomerates having too small of an average particle size can cause high-pressure drops in a fluid treatment circuit comprising the rare earth-containing agglomerates, while earth-containing agglomerates having too large of an average particle size can cause channeling in the fluid treatment circuit. In some embodiments, the rare earth-containing agglomerates have a mean, median, or P₉₀ size commonly in the range of from about 200 to about 600 microns, even more commonly in the range of from about 300 to about 500 microns, and even more commonly in the range of from about 300 to about 425 microns.

In some embodiments, the rare earth-containing agglomerates comprise at least most of the comminuted-strands having a particle size of typically from about 106 microns to about 600 microns, more typically from about 180 microns to about 500 microns, even more typically from about 300 microns to about 425 microns. In some embodiments, the rare earth-containing agglomerates comprise commonly at least about 50 wt %, more commonly at least about 60 wt %, even more commonly at least about 70 wt %, yet even more commonly at least about 75 wt %, still yet even more commonly at least about 80 wt %, still yet even more commonly at least about 90 wt %, still yet at least about 95 wt %, or still yet at least about 98 wt % of the comminuted-strands having a particle size typically from about 1.2 mm, more typically from about 1.0 mm, even more typically from about 0.8 mm, yet even more typically from about 0.7 mm, still yet even more typically from about 0.6 mm, still yet even more typically from about 0.5 mm, still yet even more typically from about 0.47 mm, still yet even more typically from about 0.45 mm, still yet even more typically from about 0.42 mm, still yet even more typically from about 0.40 mm, still yet even more typically from about 0.37 mm, still yet even more typically from about 0.35 mm, still yet even more typically from about 0.32 mm or still yet even more typically from about 0.30 mm to typically about 0.6 mm, more typically about 0.5 mm, even more typically about 0.47 mm, yet even more typically about 0.45 mm, still yet even more typically about 0.42 mm, still yet even more typically about 0.40 mm, still yet even more typically about 0.37 mm, still yet even more typically about 0.35 mm, still yet even more typically about 0.32 mm, still yet even more typically about 0.30 mm, still yet even more typically about 0.25 mm, still yet even more typically about 0.20 mm, still yet even more typically about 0.15 mm or still yet more typically about 0.10 mm. In some embodiments, the filter media strands comprise at least about 95 wt % of the comminuted-strands having a particle size from about 0.20 mm to about 0.42 mm. In some other embodiments, the rare earth-containing agglomerates comprise at least about 75 wt % of the comminuted-strands having a particle size from about 0.3 mm to about 0.42 mm.

In some configurations, the median, mean and/or P₉₀ size of the rare earth-containing agglomerates are commonly at least about 100 microns, more commonly at least about 250 microns, even more commonly at least about 500 microns, yet even more commonly at least about 750 microns, still yet even more commonly at least about 1 mm, still yet even more commonly at least about 5 mm, still yet even more commonly at least about 7.5 mm, and still yet even more commonly at least about 10 mm.

In some embodiments, the rare-earth containing agglomerates have a fine content. The fines may be from one or both of the comminuting process or from damage and/or breakage of the rare earth-containing agglomerates during shipping, storage, and/or use of the rare earth-containing agglomerates. While not wanting to be limited by theory, it is believed that the fines, can impede fluid flow in a contamination-removal device comprising the rare earth-containing agglomerates. The fluid flow decrease can be due to decrease porosity and permeability of the contaminate removal device. Furthermore, the decreased porosity and/or permeability due to the fines can decrease the efficacy of the contaminate removal device to remove contaminants and/or increase the pressure drop across the contaminate removal device. Non-limiting examples of contaminate-removal devices comprising the rare earth-containing agglomerate are filters, filter beds, and such.

Protocols were developed to measure the fine content. The protocols can measure one and/or both of the fines produced during the comminuting process and the fines that may be produced during shipping, storage and/or use of the rare earth-containing agglomerate. The protocols determine the fine content by applying ultrasonic energy to a sample containing water and the rare earth-containing agglomerate. The fine content of the rare earth-containing agglomerate corresponds to the amount of fines suspended in water after applying the ultrasound energy to the mixture. The ultrasound energy is believed to one or both of suspend fines generated during the agglomeration process and/or generate fines by damaging less robust rare earth-containing agglomerates that could have potential to be broken and/or damaged during shipping, storage, and/or use of the rare earth-containing agglomerate.

While not wanting to be limited by theory, it is believed that fine content as determine by the application of ultrasonic energy is a comparative measure of breaking strength of the rare earth-containing agglomerates. More specifically, it is believed that rare earth-containing agglomerates having a low breaking strength generate more fines than rare earth-containing agglomerates having a greater breaking strength. In other words, the lower the fine content the greater the breaking strength. Moreover, it can be appreciated that the amount ultrasonic energy applied to the rare earth-containing agglomerates during the testing protocol can affect the fine content measurement. Typically, the greater the total energy input during the protocol the greater the suspendable fine content. Therefore, the energy input and duration of the energy input should be about the same for the rare earth-containing agglomerates being evaluated in the comparative fine content protocol.

While not wanting to be limited by example, it is believed that commonly the fines suspendable in water have a particle size of less than about 180 microns. Typically the amount of fines suspended in water is expressed in terms of milligrams of fines per gram of the rare earth-containing agglomerate sample and/or in terms of turbidity, commonly expressed in Nephelometric Turbidity Units (NTU). In some instances, the fine content of the rare earth-containing agglomerate is expressed in NTU per gram of the rare earth-containing agglomerate sample per mL of water.

In some embodiments, the fine content of the rare earth-containing agglomerate is commonly no more than about 250 mg/g, more commonly no more than about 200 mg/g, even more commonly no more than about 150 mg/g, yet even more commonly no more than about 125 mg/g, still yet even commonly no more than about 100 mg/g, still yet even commonly no more than about 90 mg/g, still yet even commonly no more than about 80 mg/g, still yet even commonly no more than about 70 mg/g, still yet even commonly no more than about 60 mg/g, still yet even commonly no more than about 50 mg/g, still yet even commonly no more than about 45 mg/g, still yet even commonly no more than about 40 mg/g, still yet even commonly no more than about 35 mg/g, still yet even commonly no more than about 30 mg/g, still yet even commonly no more than about 25 mg/g, still yet even commonly no more than about 20 mg/g, still yet even commonly no more than about 15 mg/g, still yet even commonly no more than about 10 mg/g, still yet even commonly no more than about 5 mg/g or still yet even commonly no more than about 1 mg/g.

In some embodiments, the fine content of the rare earth-containing agglomerate is commonly no more than about 500 NTU, more commonly no more than about 400 NTU, even more commonly no more than about 300 NTU, yet even more commonly no more than about 250 NTU, still yet even commonly no more than about 200 NTU, still yet even commonly no more than about 180 NTU, still yet even commonly no more than about 160 NTU, still yet even commonly no more than about 140 NTU, still yet even commonly no more than about 120 NTU, still yet even commonly no more than about 100 NTU, still yet even commonly no more than about 80 NTU, still yet even commonly no more than about 60 NTU, still yet even commonly no more than about 50 NTU, still yet even commonly no more than about 40 NTU, still yet even commonly no more than about 30 NTU, still yet even commonly no more than about 20 NTU, still yet even commonly no more than about 10 NTU, still yet even commonly no more than about 5 NTU, still yet even commonly no more than about 1 NTU or still yet even commonly no more than about 0.5 NTU.

In some embodiments, the fine content of the rare earth-containing agglomerate is typically no more than about 500 NTU/g/mL, more typically no more than about 400 NTU/g/mL, even more typically no more than about 300 NTU/g/mL, yet even more typically no more than about 250 NTU/g/mL, still yet even typically no more than about 200 NTU/g/mL, still yet even typically no more than about 180 NTU/g/mL, still yet even typically no more than about 160 NTU/g/mL, still yet even typically no more than about 140 NTU/g/mL, still yet even typically no more than about 120 NTU/g/mL, still yet even typically no more than about 100 NTU/g/mL, still yet even typically no more than about 80 NTU/g/mL, still yet even typically no more than about 60 NTU/g/mL, still yet even typically no more than about 50 NTU/g/mL, still yet even typically no more than about 40 NTU/g/mL, still yet even typically no more than about 30 NTU/g/mL, still yet even typically no more than about 20 NTU/g/mL, still yet even typically no more than about 10 NTU/g/mL, still yet even typically no more than about 5 NTU/g/mL, still yet even typically no more than about 1 NTU/g/mL or still yet even typically no more than about 0.5 NTU/g/mL.

The rare earth-containing agglomerates have an aspect ratio. The aspect ratio is the ratio of the rare earth-containing agglomerate length to the rare earth-containing agglomerate width. Commonly the aspect ratio is from about 0.5:1 to about 5:1, more commonly from about 0.6:1 to about 1.8:1, even more commonly from about 0.7:1 to about 1.6:1, yet even more commonly from about 0.8:1 to about 1.4:1, or still yet even more commonly from about 0.9:1 to about 1.2:2. Preferably, the aspect ratio of the rare earth-containing agglomerate is about 1:1. Typically the rare earth-containing agglomerate width substantially corresponds to the width of the extrusion screen aperture or extrusion die aperture. In some embodiments, the aspect ratio is from 0.5:1 to 5:1.

The rare earth-containing agglomerates can have a packing density. The packing density can be commonly about 0.8 g/cm³, more commonly about 0.9 g/cm³, even more commonly about 1.0 g/cm³, yet even commonly about 1.1 g/cm³, still yet even more commonly about 1.2 g/cm³, still yet even more commonly about 1.3 g/cm³, still yet even more commonly about 1.4 g/cm³, still yet even more commonly about 1.5 g/cm³, still yet even more commonly about 1.6 g/cm³, still yet even more commonly about 1.7 g/cm³, still yet even more commonly about 1.8 g/cm³, still yet even more commonly about 1.9 g/cm³ or still yet even more commonly about 2.0 g/cm³. Preferably, the packing density is typically from about 1.1 to about 1.7 g/cm³, more preferably from about 1.2 to about 1.6 g/cm³. Even more preferably, the packing density is from about 1.3 to about 1.5 g/cm³.

The rare earth-containing agglomerates can have a mean and/or median agglomerate surface area. Commonly, the rare earth-containing agglomerate surface area is commonly from about 5 to about 250 m²/g, more commonly from about 10 to about 200 m²/g, even more commonly from about 20 to about 180 m²/g, yet even more commonly from about 20 to about 150 m²/g, still yet even more commonly from about 25 to about 150 m²/g, still yet even more commonly from about 25 to about 150 m²/g, still yet even more commonly from about 25 to about 100 m²/g, and still yet even more commonly from about 25 to about 50 m²/g.

In some embodiments, the rare earth-containing agglomerates have a mean and/or median agglomerate pore volume. The mean and/or median agglomerate pore volume is typically at least about 0.02 cm³/g, more typically at least about 0.04 cm³/g, even more typically at least about 0.06 cm³/g, yet even more typically at least about 0.08 cm³/g, still yet even more typically at least about 0.1 cm³/g, still yet even more typically at least about 0.2 cm³/g, still yet even more typically at least about 0.3 cm³/g, still yet even more typically at least about 0.5 cm³/g, or still yet even more typically at least about 1 cm³/g.

In some embodiments, the rare earth-containing agglomerates have a mean and/or median agglomerate pore size. The mean and/or median pore size of the rare earth-containing agglomerates commonly can be more than about 1 nm, more commonly more than about 2 nm, even more commonly more than about 3 nm, yet even more commonly more than about 5 nm, still yet even more commonly more than about 8 nm, still yet even more commonly more than about 10 nm, still yet even more commonly more than about 12 nm, still yet even more commonly more than about 14 nm, still yet even more commonly more than about 16 nm, still yet even more commonly more than about 18 nm, still yet even more commonly more than about 20 nm or still yet even more commonly more than about 25 nm. Typically, the agglomerate pore size corresponds to the mean and/or median pore diameter of the rare earth-containing agglomerate.

Preferably, the rare earth-containing agglomerates can have a mean and/or median agglomerate pore volume commonly from about 0.02 cm³/g to about 1 cm³/g, more preferably from about 0.1 cm³/g to about 0.5 cm³/g. Even more preferably, the rare earth-containing agglomerates have a median and/or mean agglomerate pore volume from about 0.1 cm³/g to about 0.2 cm³/g.

Preferably, the rare earth-containing agglomerate can have a mean and/or median agglomerate pore size commonly from about 1 to about 24 nm, more commonly from about 2 to about 20 nm, and even more commonly from about 2.5 to about 20 nm. In one formulation, the rare earth-containing agglomerate commonly can have a mean and/or median agglomerate pore size from about 2 to about 6 nm, and more commonly from about 2.5 to about 5.5 nm. In one formulation, the rare earth-containing agglomerate commonly can have a mean and/or median agglomerate pore size from about 10 to about 25 nm, and more commonly from about 15 to about 20 nm.

In some embodiments, the agglomerate pore sized is one of a mean and/or median pore size of commonly at least about 3 nm, more commonly of at least about 5 nm, even more commonly of at least about 10 nm, yet even more commonly at least about 15 nm and even more commonly of at least about 20 nm and of commonly no more than about 50 nm, more commonly of at no more than about 30 nm, even more commonly of no more than about 20 nm, yet even more commonly of no more than about 15 nm, and still yet even more commonly no more than about 10 nm. The agglomerate pore volume is one of a mean and/or median of commonly at least about 0.01 cm³/g, even more commonly at least about 0.05 cm³/g, yet even more commonly at least about 0.10 cm³/g, still yet even more commonly at least about 0.15 cm³/g, still yet even more commonly at least about 0.20 cm³/g and even more commonly at least about 0.25 cm³/g.

In some formulations, the rare earth-containing can comprise rare earth-containing particles having a mean, median and/or P₉₀ size of about 1 micron or more. In such formulations, the rare earth-containing agglomerate can have a mean and/or median agglomerate pore size of commonly from about 1 n to about 10 nm, more commonly from about 2 n to about 8 nm, even more commonly from about 3 to about 7 nm, or yet even more commonly from about 4 to about 6 nm and an agglomerate mean and/or median agglomerate pore volume size of commonly from about 0.01 to about 0.10 cm³/g, more commonly from about 0.02 to about 0.08 cm³/g, even more commonly from about 0.03 to about 0.07 cm³/g, or yet even more commonly from 0.4 to about 0.06 cm³/g. The rare earth-containing agglomerates of this formulation can have an agglomerate pore diameter of at least about 2.5 nm and more commonly of at least about 5 nm and commonly of no more than about 25 nm, more commonly of no more than about 35 nm, and even more commonly of no more than about 40 nm. Furthermore, the rare earth-containing agglomerates of the this formulation can commonly have an agglomerate pore volume of at least about 0.025 cm³/g and even more commonly at least about 0.05 cm³/g.

In some formulations, the rare earth-containing agglomerate can comprise rare earth-containing particles having a mean, median and/or P₉₀ size from of commonly of less than about 1 micron. In such formulations, the rare earth-containing agglomerates can have a mean and/or median agglomerate pore size of commonly from about 5 to about 30 nm, more commonly from about 10 to about 25 nm, even more commonly from about 16 to about 20 nm, or yet even more commonly from about 17 to about 19 nm and an agglomerate mean and/or median agglomerate pore volume size of commonly from about 0.01 to about 0.9 cm³/g, more commonly from about 0.03 to about 0.7 cm³/g, even more commonly from about 0.05 to about 0.5 cm³/g, or yet even more commonly from 0.1 to about 0.3 cm³/g. The rare earth-containing agglomerates of this formulation can commonly have an agglomerate pore diameter of at least about 10 nm, more commonly of at least about 15 nm, even more commonly of at least about 20 nm, and yet even more commonly of at least about 25 nm and of no more than about 75 nm, more commonly of no more than about 50 nm, more commonly no more than about 40, and even more commonly of no more than about 35 nm. Furthermore, the rare earth-containing agglomerates of this formulation can commonly have an agglomerate pore volume of at least about 0.1 cm³/g and even more commonly at least about 15 cm³/g.

While not wanting to be bound by any theory, it is believed that the agglomerate surface area, pore size and/or pore volume significantly contributor to contaminant removal performance of the rare earth-containing agglomerate. More specifically, the greater the agglomerate surface area, pore size and/or pore volume the greater the contaminant removal capacity and/or efficiency of the rare earth-containing agglomerate. The rare earth-containing agglomerates have a weight percent of the polymeric material. The weight percent of the polymeric material in the rare earth-containing agglomerate is designated herein as “wt % polymer”. In some embodiments, one or more of the rare earth-containing agglomerates and/or dried, cured, comminuted and filter media strands typically have no more than about 0.1 wt % polymer, more typically have no more than about 0.5 wt % polymer, even more typically have no more than about 1 wt % polymer, yet even more typically have no more than about 2 wt % polymer, still yet even more typically have no more than about 3 wt % polymer, still yet even more typically have no more than about 4 wt % polymer, still yet even more typically have no more than about 5 wt % polymer, still yet even more typically have no more than about 6 wt % polymer, still yet even more typically have no more than about 7 wt % polymer, still yet even more typically have no more than about 8 wt % polymer, still yet even more typically have no more than about 10 wt % polymer, still yet even more typically have no more than about 12 wt % polymer or still yet even more typically have no more than about 15 wt % polymer. Preferably, the rare earth-containing agglomerates commonly have from about 0.1 to about 15 wt % polymer, more commonly from about 0.5 to about 12 wt % polymer, even more commonly from about 1 to about 5 wt % polymer and yet even more commonly from about 1 to about 3 wt % polymer. In some embodiments, the rare earth-containing agglomerates have about 2 wt % polymer.

The rare earth-containing agglomerates have a weight percent of the rare earth-containing particles. In some embodiments the rare earth-containing particles typically have more than about 88 wt % rare earth-containing particles, more typically more than about 90 wt % rare earth-containing particles, even more typically have more than about 92 wt % rare earth-containing particles, yet even more typically have more than about 93 wt % rare earth-containing particles, still yet even more typically have more than about 94 wt % rare earth-containing particles, still yet even more typically have more than about 95 wt % rare earth-containing particles, still yet even more typically have more than about 96 wt % rare earth-containing particles, still yet even more typically have more than about 97 wt % rare earth-containing particles, still yet even more typically have more than about 98 wt % rare earth-containing particles, still yet even more typically have more than about 99 wt % rare earth-containing particles, and yet still even more typically have more than about 99.5 wt % rare earth-containing particles.

In some embodiments, the rare earth-containing agglomerates commonly have from about 90 to about 99.9 wt % rare earth-containing particles, more commonly from about 95 to about 99.5 wt % rare earth-containing particles, and even more commonly from about 97 to about 99 wt % rare earth-containing particles. In some embodiments, the rare earth-containing agglomerates have about 98 wt rare earth-containing particles.

The rare earth-containing agglomerates can have improved wettability and/or contaminant (e.g., arsenic) removal capacity. Furthermore, the rare earth-containing agglomerates can be permeable to fluid flow and have a low flow resistance, preferably to an aqueous fluid flow. By way of example, the pressure drop across a bed of the rare earth-containing agglomerates typically can be less than about 100 psi, more typically less than about 90 psi, even more typically less than about 80 psi, yet even more typically less than about 70 psi, still yet even more typically less than about 60 psi, still yet even more typically less than about 50 psi, still yet even more typically less than about 40 psi, still yet even more typically less than about 30 psi, still yet even more typically less than about 20 psi, still yet even more typically less than about 10 psi, or still yet more commonly less than about 5 psi.

The rare earth-containing agglomerates can be highly effective in removing, by precipitation or sorbtion (depending on the solution conditions) various contaminants, such as biological materials (e.g., bacteria, fungi, prions, and other microbes), chemical warfare agents, pesticides, insecticides, rodenticides, herbicides, oxyanions, and other contaminants. The rare earth may be a soluble rare earth composition, an insoluble rare composition or a composition containing soluble and insoluble rare earth compositions. Insoluble rare earth compositions are preferred. A particularly preferred rare earth composition is cerium dioxide.

In some embodiments, the rare earth-containing agglomerates can also be made by sintering and/or by compaction. The agglomerates are then comminuted to the required particle size range and/or distribution. Generally, particles formed from agglomerates made by sintering and compacting can form a large amount of fines. Sintering in the presence of the binder can strengthen the agglomerate and can reduce the fine content of the rare earth-containing agglomerates. Non-limiting examples of a compactor is a roller-press compactor. Typically, compaction can be at a high pressure and/or a high temperature. Powdered polymeric binder and the rare earth particles are mixed in a dry state using, for example, a rotating blade mixed prior to pressure densification. If a binder is used, the binder must be thermally stable and compatible with the rare earth-containing material. Oxidation of binder can occur at the high temperature and/or pressure leading to binder degradation and even combustion. This technique is generally not preferred due to the friable nature of rare earth-containing particles. Furthermore, melt agglomeration techniques are generally not preferred.

In some embodiments, the agglomerates can be used to removal one or more contaminates from a fluid. The contaminate-containing fluid may comprise a gas or liquid. Preferably, the gas comprises air and the liquid comprises an aqueous stream. The contaminant may comprise a biological contaminant, microbe, microorganism, chemical contaminant, chemical agent or a combination and/or mixture thereof. The contaminant can be arsenic, arsenate, arsenite, fluoride, a pharmaceutical, a personal care chemical, a pesticide, an insecticide, a herbicide, a rodenticide, a fungicide, humic acid, tannic acid, an oxyanion, a dye (including a dye carrier and dye intermediate), a pigment, a colorant, an ink, a chemical contaminant, or mixture thereof.

The terms “biological contaminant”, “microbe”, “microorganism”, and the like include bacteria, fungi, protozoa, viruses, molds, algae and other biological entities and pathogenic species that can be found in gases and/or aqueous solution. Specific non-limiting examples of biological contaminants can include bacteria such as Escherichia coli, Streptococcus faecalis, Shigella spp, Leptospira, Legimella pneumophila, Yersinia enterocolitica, Staphylococcus aureus, Pseudomonas aeruginosa, Klebsiella terrigena, Bacillus anthracis, Vibrio cholerae and Salmonella typhi, viruses such as hepatitis A, noroviruses, rotaviruses, and enteroviruses, protozoa such as Entamoeba histolytica, Giardia, Cryptosporidium parvum and others. Biological contaminants can also include various species such as fungi or algae that are generally non-pathogenic but which are advantageously removed. How such biological contaminants came to be present in the gas and/or aqueous environment, either through natural occurrence or through intentional or unintentional contamination, is non-limiting of the invention.

The term “chemical contaminant” or “chemical agent” includes known chemical warfare agents and industrial chemicals and materials such as dyes, pigments, inks, dye intermediates, dye carriers, pesticides, insecticides and fertilizers. In some embodiments, the chemical contaminant can include one or more of an organosulfur agent, an organophosphorous agent or a mixture thereof. Specific non-limiting examples of such agents include o-alkyl phosphonofluoridates, such as sarin and soman, o-alkyl phosphoramidocyanidates, such as tabun, o-alkyl, s-2-dialkyl aminoethyl alkylphosphonothiolates and corresponding alkylated or protonated salts, such as VX, mustard compounds including, 2-chloroethylchloromethylsulfide, bis(2-chloroethyl)sulfide, bis(2-chloroethylthio)methane, 1,2-bis(2-chloroethylthio)ethane, 1,3-bis(2-chloroethylthio)-n-propane, 1,4-bis(2-chloroethylthio)-n-butane, 1,5-bis(2-chloroethylthio)-n-pentane, bis(2-chloroethylthiomethyl)ether, and bis(2-chloroethylthioethyl)ether, Lewisites, including 2-chlorovinyldichloroarsine, bis(2-chlorovinyl)chloroarsine, tris(2-chlorovinyl)arsine, bis(2-chloroethyl)ethylamine, and bis(2-chloroethyl)methylamine, saxitoxin, ricin, alkyl phosphonyldifluoride, alkyl phosphonites, chlorosarin, chlorosoman, amiton, 1,1,3,3,3-pentafluoro-2-(trifluoromethyl)-1-propene, 3-quinuclidinyl benzilate, methylphosphonyl dichloride, dimethyl methylphosphonate, dialkyl phosphoramide dihalides, alkyl phosphoramidates, diphenyl hydroxyacetic acid, quinuclidin-3-ol, dialkyl aminoethyl-2-chlorides, dialkyl aminoethane-2-ols, dialkyl aminoethane-2-thiols, thiodiglycols, pinacolyl alcohols, phosgene, cyanogen chloride, hydrogen cyanide, chloropicrin, phosphorous oxychloride, phosphorous trichloride, phosphorus pentachloride, alkyl phosphorous oxychloride, alkyl phosphites, phosphorous trichloride, phosphorus pentachloride, alkyl phosphites, sulfur monochloride, sulfur dichloride, and thionyl chloride.

Non-limiting examples of industrial chemical and materials that may be effectively treated with the compositions described herein including materials that have anionic functional groups such as phosphates, sulfates and nitrates, electro-negative and/or electron withdrawing functional groups and/or elements, such as chlorides, fluorides, bromides, ethers and carbonyls. Specific non-limiting examples can include acetaldehyde, acetone, acrolein, acrylamide, acrylic acid, acrylonitrile, aldrin/dieldrin, ammonia, aniline, arsenic, atrazine, barium, benzidine, 2,3-benzofuran, beryllium, 1,1′-biphenyl, bis(2-chloroethyl)ether, bis(chloromethyl)ether, bromodichloromethane, bromoform, bromometliane, 1,3-butadiene, 1-butanol, 2-butanone, 2-butoxyethanol, butraldehyde, carbon disulfide, carbon tetrachloride, carbonyl sulfide, chlordane, chlordecone and mirex, chlorfenvinphos, chlorinated dibenzo-p-dioxins (CDDs), chlorine, chlorobenzene, chlorodibenzofurans (CDFs), chloroethane, chloroform, chloromethane, chlorophenols, chlorpyrifos, cobalt, copper, creosote, cresols, cyanide, cyclohexane, DDT, DDE, DDD, DEHP, di(2-ethylhexyl)phthalate, diazinon, dibromochloropropane, 1,2-dibromoethane, 1,4-dichlorobenzene, 3,3′-dichlorobenzidine, 1,1-dichloroethane, 1,2-dichloroethane, 1,1-dichloroethene, 1,2-dichloroethene, 1,2-dichloropropane, 1,3-dichloropropene, dichlorvos, diethyl phthalate, diisopropyl methylphosphonate, di-n-butylphtalate, dimethoate, 1,3-dinitrobenzene, dinitrocresols, dinitrophenols, 2,4- and 2,6-dinitrotoluene, 1,2-diphenylhydrazine, di-n-octylphthalate (DNOP), 1,4-dioxane, dioxins, disulfoton, endosulfan, endrin, ethion, ethylbenzene, ethylene oxide, ethylene glycol, ethylparathion, fenthions, fluorides, formaldehyde, freon 113, heptachlor and heptachlor epoxide, hexachlorobenzene, hexachlorobutadiene, hexachlorocyclohexane, hexachlorocyclopentadiene, hexachloroethane, hexamethylene diisocyanate, hexane, 2-hexanone, HMX (octogen), hydraulic fluids, hydrazines, hydrogen sulfide, iodine, isophorone, malathion, MBOCA, methamidophos, methanol, methoxychlor, 2-methoxyethanol, methyl ethyl ketone, methyl isobutyl ketone, methyl mercaptan, methylparathion, methyl t-butyl ether, methylchloroform, methylene chloride, methylenedianiline, methyl methacrylate, methyl-tert-butyl ether, mirex and chlordecone, monocrotophos, N-nitrosodimethylamine, N-nitrosodiphenylamine, N-nitrosodi-n-propylainine, naphthalene, nitrobenzene, nitrophenols, perchloroethylene, pentachlorophenol, phenol, phosphamidon, phosphorus, polybrominated biphenyls (PBBs), polychlorinated biphenyls (PCBs), polycyclic aromatic hydrocarbons (PAHs), propylene glycol, phthalic anhydride, pyrethrins and pyrethroids, pyridine, RDX (cyclonite), selenium, styrene, sulfur dioxide, sulfur trioxide, sulfuric acid, 1,1,2,2-tetrachloroethane, tetrachloroethylene, tetryl, thallium, tetrachloride, trichlorobenzene, 1,1,1-trichloroethane, 1,1,2-trichloroethane, trichloroethylene (TCE), 1,2,3-trichloropropane, 1,2,4-trimethylbenzene, 1,3,5-trinitrobenzene, 2,4,6-trinitrotoluene (TNT), vinyl acetate, and vinyl chloride.

A “dye” is a colorant, usually transparent, which is soluble in an application medium. Dyes are classified according to chemical structure, usage, or application method. They are composed of groups of atoms responsible for the dye color, called chromophores, and intensity of the dye color, called auxchromes. The chemical structure classification of dyes, for example, uses terms such as azo dyes (e.g., monoazo, disazo, trisazo, polyazo, hydroxyazo, carboxyazo, carbocyclic azo, heterocyclic azo (e.g., indoles, pyrazolones, and pyridones), azophenol, aminoazo, and metalized (e.g., copper (II), chromium (III), and cobalt (III)) azo dyes, and mixtures thereof), anthraquinone (e.g., tetra-substituted, disubstituted, trisubstituted and momosubstitued, anthroaquinone dyes (e.g., quinolines), premetallized anthraquinone dyes (including polycyclic quinones), and mixtures thereof), benzodifuranone dyes, polycyclic aromatic carbonyl dyes, indigoid dyes, polymethine dyes (e.g., azacarobocyanine, diazacarbocyanine, cyanine, hemicyanine, and diazahemicyanine dyes, triazolium, benothiazolium, and mixtures thereof), styryl dyes, (e.g., dicyanovinyl, tricyanovinyl, tetracyanoctylene dyes) diaryl carbonium dyes, triaryl carbonium dyes, and heterocyclic derivates thereof (e.g., triphenylmethane, diphenylmethane, thiazine, triphendioxazine, pyronine (xanthene) derivatives and mixtures thereof), phthalocyanine dyes (including metalized phthalocyanine dyes), quinophthalone dyes, sulfur dyes, (e.g., phenothiazonethianthrone) nitro and nitroso dyes (e.g., nitrodiphenylamines, metal-complex derivatives of o-nitrosophenols, derivatives of naphthols, and mixtures thereof), stilbene dyes, formazan dyes, hydrazone dyes (e.g., isomeric 2-phenylazo-1-naphthols, 1-phenylazo-2-naphthols, azopyrazolones, azopyridones, and azoacetoacetanilides), azine dyes, xanthene dyes, triarylmethane dyes, azine dyes, acridine dyes, oxazine dyes, pyrazole dyes, pyrazalone dyes, pyrazoline dyes, pyrazalone dyes, coumarin dye, naphthalimide dyes, carotenoid dyes (e.g., aldehydic carotenoid, β-carotene, canthaxanthin, and β-Apo-8′-carotenal), flavonol dyes, flavone dyes, chroman dye, aniline black dye, indeterminate structures, basic dye, quinacridone dye, formazan dye, triphendioxazine dye, thiazine dye, ketone amine dyes, caramel dye, poly(hydroxyethyl methacrylate)-dye copolymers, riboflavin, and copolymers, derivatives, and mixtures thereof. The application method classification of dyes uses the terms reactive dyes, direct dyes, mordant dyes, pigment dyes, anionic dyes, ingrain dyes, vat dyes, sulfur dyes, disperse dyes, basic dyes, cationic dyes, solvent dyes, and acid dyes.

A “dye carrier”, or dyeing accelerant, enables dye penetration into fibers, particularly polyester, cellulose acetate, polyamide, polyacrylic, and cellulose triacetate fibers. The penetration of the dye carrier into the fiber lowers the glass-transition temperature, T_{g}, of the fiber and allows a water-insoluble dye to be taken into the fiber. Most dye carriers are aromatic compounds. Examples of dye carriers include phenolics (e.g., o-phenylphenol, p-phenylphenol, and methyl crestotinate), chlorinated aromatics (e.g., o-dichlorobenzene, and 1,3,5-trichlorobenzene), aromatic hydrocarbons and ethers (e.g., biphenyl, methylbiphenyl, diphenyl oxide, 1-methylnaphthalene, and 2-methylnaphthalene), aromatic esters (e.g., methyl benzoate, butyl benzoate, and benzyl benzoate), and phthalates (e.g., dimethyl phthalate, diethyl phthalate, diallyl phthalate, and dimethyl terephthalate).

A “dye intermediate” refers to a dye precursor or intermediate. A dye intermediate, as used herein, includes both primary intermediates and dye intermediates. Dye intermediates are generally divided into carbocycles, such as benzene, naphthalene, sulfonic acid, diazo-1,2,4-acid, anthraquinone, phenol, aminothiazole nitrate, aryldiazonium salts, arylalkylsulfones, toluene, anisole, aniline, anilide, and chrysazin, and heterocycles, such as pyrazolones, pyridines, indoles, triazoles, aminothiazoles, aminobenzothiazoles, benzoisothiazoles, triazines, and thiopenes.

An “ink” refers to a liquid or paste containing various pigments and/or dyes used for coloring a surface to produce an image, text, or design. Liquid ink is commonly used for drawing and/or writing with a pen, brush or quill. Paste inks are generally thicker than liquid inks Paste inks are used extensively in letterpress and lithographic printing.

A “pigment” is a synthetic or natural (biological or mineral) material that changes the color of reflected or transmitted light as the result of wavelength-selective absorption. This physical process differs from fluorescence, phosphorescence, and other forms of luminescence, in which a material emits light. The pigment may comprise inorganic and/or organic materials. Inorganic pigments include elements, their oxides, mixed oxides, sulfides, chromates, silicates, phosphates, and carbonates. Examples of inorganic pigments, include cadmium pigments, carbon pigments (e.g., carbon black), chromium pigments (e.g., chromium hydroxide green and chromium oxide green), cobalt pigments, copper pigments (e.g., chlorophyllin and potassium sodium copper chlorophyllin), pyrogallol, pyrophyllite, silver, iron oxide pigments, clay earth pigments, lead pigments (e.g., lead acetate), mercury pigments, titanium pigments (e.g., titanium dioxide), ultramarine pigments, aluminum pigments (e.g., alumina, aluminum oxide, and aluminum powder), bismuth pigments (e.g., bismuth vanadate, bismuth citrate and bismuth oxychloride), bronze powder, calcium carbonate, chromium-cobalt-aluminum oxide, cyanide iron pigments (e.g., ferric ammonium ferrocyanide, ferric and ferrocyanide), manganese violet, mica, zinc pigments (e.g., zinc oxide, zinc sulfide, and zinc sulfate), spinels, rutiles, zirconium pigments (e.g., zirconium oxide and zircon), tin pigments (e.g., cassiterite), cadmium pigments, lead chromate pigments, luminescent pigments, lithopone (which is a mixture of zinc sulfide and barium sulfate), metal effect pigments, nacreous pigments, transparent pigments, and mixtures thereof. Examples of synthetic organic pigments include ferric ammonium citrate, ferrous gluconate, dihydroxyacetone, guaiazulene, and mixtures thereof. Examples of organic pigments from biological sources include alizarin, alizarin crimson, gamboge, cochineal red, betacyanins, betataxanthins, anthocyanin, logwood extract, pearl essence, paprika, paprika oleoresins, saffron, turmeric, turmeric oleoresin, rose madder, indigo, Indian yellow, tagetes meal and extract, Tyrian purple, dried algae meal, henna, fruit juice, vegetable juice, toasted partially defatted cooked cottonseed flour, quinacridone, magenta, phthalo green, phthalo blue, copper phthalocyanine, indanthone, triarylcarbonium sulfonate, triarylcarbonium PTMA salt, triaryl carbonium Ba salt, triarylcarbonium chloride, polychloro copper phthalocyanine, polybromochlor copper phthalocyanine, monoazo, disazo pyrazolone, monoazo benzimidazolone, perinone, naphthol AS, beta-naphthol red, naphthol AS, disazo pyrazolone, BONA, beta naphthol, triarylcarbonium PTMA salt, disazo condensation, anthraquinone, perylene, diketopyrrolopyrrole, dioxazine, diarylide, isoindolinone, quinophthalone, isoindoline, monoazo benzimidazolone, monoazo pyrazolone, disazo, benzimidazolones, diarylide yellow dintraniline orange, pyrazolone orange, para red, lithol, azo condensation, lake, diaryl pyrrolopyrrole, thioindigo, aminoanthraquinone, dioxazine, isoindolinone, isoindoline, and quinphthalone pigments, and mixtures thereof. Pigments can contain only one compound, such as single metal oxides, or multiple compounds. Inclusion pigments, encapsulated pigments, and lithopones are examples of multi-compound pigments. Typically, a pigment is a solid insoluble powder or particle having a mean particle size ranging from about 0.1 to about 0.3 μm, which is dispersed in a liquid. The liquid may comprise a liquid resin, a solvent or both. Pigment-containing compositions can include extenders and opacifiers.

### EXAMPLES

### Example 1

This Example describes an agglomeration process using cerium dioxide and an emulsion comprising Aquatec Kynar-acrylic polymer and a carbodiimide cross-linker. To a 250 mL cup containing 49 mL of distilled water, 4.57 g of a 47 wt % Aquatec Kynar-acrylic aqueous solution and 1.34 g of a 40 wt % carbodiimide aqueous solution were added with stirring to form an acrylic/carbodiimide emulsion. To the acrylic/carbodimide emulsion 134.13 g of particulate cerium dioxide (CeO₂) was added to form a particulate mixture. The 134.13 g of particulate CeO₂ was added in two increments, the first increment was about 100 g and second increment was about 34.13 g. The cerium dioxide particulates had a particle size from about 30 to about 50 microns. The particulate mixture was transferred to a Keyence hybrid mixer and mixed twice to produce a paste of wet agglomerated particles. Each mixing time period was about 30 seconds. The paste was transferred to a basket extruder equipped with a 0.6 mm screen and extruded through the screen to form strands. The strands were extrudated into a circulating hot air flow having a temperature of about 60 to about 70 degrees Celsius. The extruded strands were collected and dried for about two hours in an oven at a temperature of about 60 degrees Celsius. After oven drying, the extruded strands were cured at a temperature of about 120 degrees Celsius for about two hours. The cured strands were broken into shorter strands. The shorter strands were sieved through a stack of differing sized screens. The screen sizes ranged from about 106 to about 850 μm. Differing size fractions of the shorter strands were collected by each of the differing sized screens. Each of the differing size fractions were collected and weighed. The shorter strands comprised agglomerated cerium dioxide, more specifically the shorter strands comprised cerium dioxide agglomerated with Aquatec Kynar-acrylic polymer crosslinked with carbodiimide.

### Example 2

Cerium dioxide (CeO₂) can effectively remove arsenic from arsenic-containing waters. More particularly, arsenic can be removed from arsenic-containing waters by a filter bed of particulate cerium dioxide. However, particulate cerium dioxide can contain fines. The fines can create a significant pressure drop when the filter bed is challenged at a high flow rate. In this example, a cerium dioxide filter bed was made with the micron particulate CeO₂ (particle size from about 30 to about 50 microns) used to form the shorter strands. When the filter bed was challenged at about 0.5 bed volume per minute flow rate, a pressure drop of about 17 psi was generated. However, a much smaller pressure drop was generated when agglomerated cerium dioxide was challenged under similar flow-rate conditions. For example, a pressure drop of less than about 1 psi was generated when a bed comprising from about 425 to about 600 micron agglomerated material of Example 1.

### Example 3

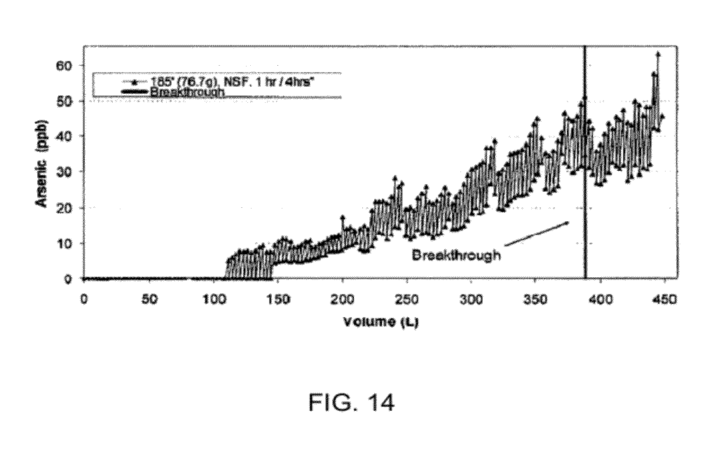

This Example shows that the agglomeration of cerium dioxide does not substantially impair the ability of cerium dioxide to effectively remove arsenic from arsenic-containing waters. About 76 grams of the agglomerated media of Example 1 was formed into a 63 cm³ filter bed. An arsenic (V)-containing water having about 300 ppb of arsenic was treated with the 63 cm³ agglomerated media filter bed. About 388 L of the arsenic (V)-containing water was treated before the breakthrough limit of 50 ppb arsenic (see FIG. 14).

### Example 4

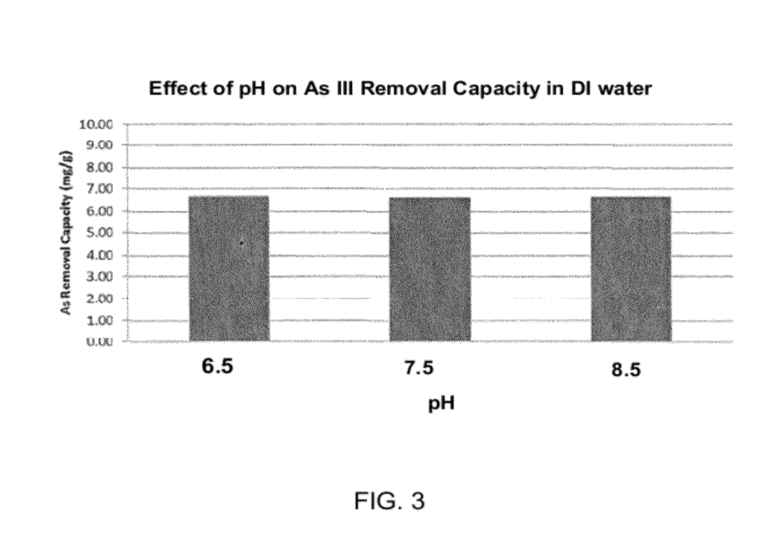

In this Example, the efficacy of agglomerated cerium dioxide to remove arsenic from an arsenic-containing solution was determined. The efficacy testing was conducted at an exposure rate of about 0.67 bed volumes per minute. The arsenic removal capacity was derived from removal isotherms. The removal isotherms were determined with 20 mg samples of the agglomerated cerium dioxide exposed for about 24 hours to 0.5 L of a 500 ppb arsenic (III)-containing deionized water solution (see Table 1 and FIG. 3). The effect of pH on the arsenic removal isotherms was determined for arsenic-containing solutions having pH values of pH 6.5, 7.5 and 8.5 The arsenic (III)-containing solutions were buffered to their respective pH values with 0.125 mMol 4-(2-hydroxyethyl)-1-piperazineethanesulfonic acid (HEPES). An analysis of the arsenic (III)-containing solutions found significant amounts of arsenic (V) in the solutions during the testing period. The isotherm measurements showed insignificant variation in arsenic (III) removal by the agglomerated cerium dioxide over the pH 6.5 to pH 8.5 range tested.

TABLE 1

| | | Initial | Vol | Test | Mass | Final | Removal |
|---|---|---|---|---|---|---|---|
| | | [As] | Tested | Time | Media | [As] | Capacity |
| Media | pH | (ppb) | (L) | (hr) | (g) | (ppb) | (mg/g) |
| Agglomerated | 6.5 | 530 | 0.5 | 24 | 0.0204 | 257 | 6.69 |
| Ceria | | | | | | | |
| Agglomerated | 7.5 | 530 | 0.5 | 24 | 0.0213 | 248 | 6.62 |
| Ceria | | | | | | | |
| Agglomerated | 8.5 | 530 | 0.5 | 24 | 0.0202 | 262 | 6.65 |
| Ceria | | | | | | | |

24 hour isotherms, 20 mg of agglomerated ceria exposed to 0.5 L of 500 ppb As(III)

### Example 5

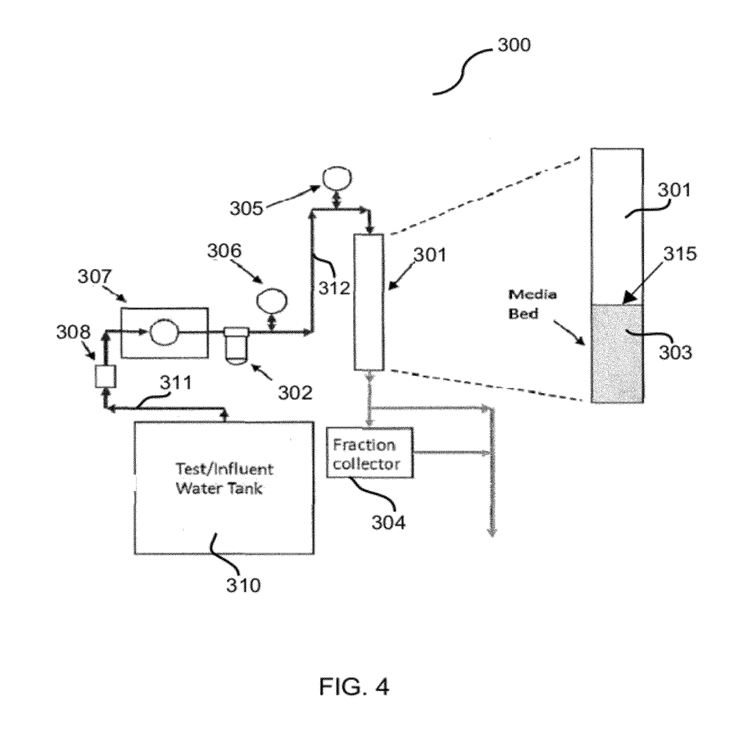

FIG. 4 depicts column set-up 300 used in this example to determine pressure drop in a filter bed of agglomerated cerium dioxide. Column 301 was packed with filter bed media 303. In this particular example, the filter bed media 303 was agglomerated cerium dioxide. Fluid 310 is charged to the column 301 through column in-put line 312 and discharged through column out-put line 313. Pump 307 is interconnected to tank line 311 and column in-put line 312, and withdraws through tank line 311 the fluid 301 from tank 309. The column output line 313 may optionally include a fluid collector 304. Fluid collector 304 may be a device for measuring flow rate, such as gravimetric device. A first optional filter 308 may be positioned in tank line 311 between the tank 309 and pump 307. Furthermore, one or more of an optional second filter 302, optional flow rate gauge 306 and optional pressure gauge 305 may be positioned between the pump 307 and column 301. Optional three-way ball valves used to redirect the flow between reverse flow (to fluidize the bed) and normal operational flow are not depicted in FIG. 4.

About 653.25 g of agglomerated cerium dioxide corresponding to a bed volume of about 891 ml was rinsed several times with deionized water to substantially remove fine particles before being degassed in a vacuum flask. The agglomerated cerium dioxide had an average particle size from about 300 μm to about 425 μm. The cerium dioxide agglomerated with a PVDF binder. After being rinsed and degassed the agglomerated cerium dioxide was packed into column 301. The column 301 had an internal diameter of about 2 inches. The agglomerated cerium dioxide loaded column 301 was backwashed with deionized water to fluidize and repack the agglomerated cerium dioxide. The repacking of the agglomerated cerium dioxide by fluidization substantially homogenizes the agglomerated cerium dioxide bed and reduces, if not substantially eliminates, channeling of fluid through the repacked agglomerated cerium dioxide filter bed 303. Moreover, fluidizing and repacking of the agglomerated cerium dioxide filter bed 303 forms a level and/or smooth bed surface 315 for contacting fluid 310.

The repacked column was pressure tested with deionized water. Fluid flow rates and pressures (see FIG. 5) were determined gravimetrically, using collector 304, by measuring fluid mass exiting the output line 313 per unit time.

The flow rates tested were from about 223 mL/min to about 2,762 mL/min. The 2,762 mL/min flow rate corresponds to a rate of about 3.1 Vb/min. Pressure drops were measured about 3 to about 5 minutes after each flow rate change. A pressure drop of about 28 psi was observed at a flow rate of about 3 bed volumes per minute.

### Example 6

An agglomerated cerium dioxide packed column set-up 300 (as depicted in FIG. 4) was continuously challenged with an arsenic (III)-containing aqueous solution having about 500 parts per billion arsenic. Column 301 was about 36 inches long and had an internal diameter of about 2 inches. The column 301 was packed with about 223 grams of agglomerated cerium dioxide of Example 1. The agglomerated cerium dioxide filter bed 303 had a bed volume of about 171 mL. The agglomerated cerium dioxide was rinsed prior to packing the column 301. The packed column 301 was fluidized and repacked (as described above in Example 5) prior to being challenged with the arsenic (III)-containing aqueous solution. The repacked column was challenged with the arsenic (III)-containing solution at a flow rate of about 0.67 Vb/min, which corresponds to about 115 mL/min. The arsenic (III)-containing aqueous solution pH was adjusted to about pH 7.5 with HEPES prior to challenging the agglomerated cerium dioxide packed column. Fresh arsenic (III)-containing solution having a pH of about pH 7.5 was prepared daily.

Agglomerated cerium dioxide bed height, column pressure drop and flow rate were measured about every 60 seconds. Initial pressure drop at start-up flow rate of about 0.67 Vb/min was about 0.2 PSI. After about three weeks of continuous operation, the pressure drop increased to about 1.2 PSI. Most of the pressure drop was believed to be due to air bubbles trapped at the top of the column. The agglomerated cerium dioxide bed height remained substantially unchanged during the test period.

A slight coloration developed at the top of the agglomerated cerium dioxide bed, where the arsenic (III)-containing aqueous solution firsts encounters the agglomerated cerium dioxide. The coloration change observed is typically associated with arsenic (III)-loading of cerium dioxide. As the agglomerated cerium dioxide bed was further challenged with arsenic (III) the coloration progressed further down the agglomerated cerium dioxide bed.

Effluent samples were collected from output line 313 at two-hour intervals. The effluent samples were analyzed by inductively coupled plasma mass spectrometry (ICP MS) for arsenic and cerium. The ICP MS detection limit for arsenic is about 2 ppb and for cerium about 10 ppb. Cerium was not detected in the effluent during testing, therefore, it was concluded that the agglomerated cerium dioxide released insignificant amounts of cerium-containing fines during the test period. The pH valves of the arsenic (III)-containing solution contained within the tank 309 and output line 313 containing solution were determined about every 12 hours.

On about the twenty-second day of the arsenic (III) challenge, the column had treated more than about 3700 L of the 500 ppb arsenic (III)-containing aqueous solution. Through this test period the effluent remained below about 2 ppb arsenic and 10 ppb cerium. Furthermore, about the upper two thirds of the agglomerated cerium dioxide bed height had a slight coloration change indicative of arsenic (III)-loaded cerium dioxide.

The column effluent first contained about 10 ppb of arsenic on about the forty-seventh day of the arsenic (III) challenge, at this point about 7,645 L of 500 ppb arsenic (III)-containing aqueous solution had been treated by the 223 grams agglomerated cerium dioxide bed. This corresponds to a removal capacity of 17.1 mg of arsenic (III) per gram of the agglomerated cerium dioxide.

Table 2 provides various column configurations for removing contaminates, such as arsenic (III), under differing operating conditions. The column configurations were calculated using a 0.67 VB/min flow rate, an agglomerated cerium dioxide bed density of 1.30 g/L and a 10 ppb arsenic (III) breakthrough valve.

TABLE 2

| | | | | | | TSM | |
|---|---|---|---|---|---|---|---|
| | Original | New Flow | Flow | Column | Number | Media | Treated |
| | Flow rate | rate | Rate | Volume | of | Weight | Volume |
| System | (Vb/min) | (Vb/min) | (L/Min) | (L) | Columns | (kg) | (L)* |
| Example 3 | NA | 0.67 | 0.115 | 0.1714 | 1 | 0.223 | 7,627 |
| Calculated | 1.4 | 0.67 | 7.95 | 5.66 | 2.1 | 7.4 | 251,847 |
| Condition 1 | | | | | | | |
| Calculated | 0.84 | 0.67 | 94.6 | 113.27 | 1.3 | 147.4 | 5,040,052 |
| Condition 2 | | | | | | | |
| Calculated | 2.01 | 0.67 | 56.8 | 28.32 | 3.0 | 36.8 | 1,260,124 |
| Condition 3 | | | | | | | |
| Calculated | 0.67 | 0.67 | 189.3 | 283.17 | 1.0 | 368.4 | 12,599,909 |
| Condition 4 | | | | | | | |

### Example 7

### Initial Extraction Testing

This Example describes a modified protocol based on NSF/ANSI-61-2009 to determine to what extent organic material is released by the agglomerated cerium dioxide polymeric binder when the polymeric binder is in contact with an aqueous solution. Testing was conducted using cross-linked and non-crosslinked polymeric binders lacking cerium dioxide. Films of polymeric binders comprising Aquatech RC 10206 (sample 59-114) that was cast into a thick film and pressed into a flat sheet at 420 degrees F. and 102.2 g Aquatech RC 10206 mixed with 30.0 g Picassian XL-702 (sample 59-113) cast into flat film, dried overnight followed by crosslinking two hours at 120 degrees C. were prepared. The polymeric binder films had a thickness of from about 5 to about 7 mils.

Film samples of 12.5 g polymer film were immersed in one liter of reagent test water specified in NSF/ANSI 61-2009 Annex B9.2.1. The ratio of film to water was intended to represent the amount of polymer present in a 625 g sample of agglomerated media per liter of reagent test water.

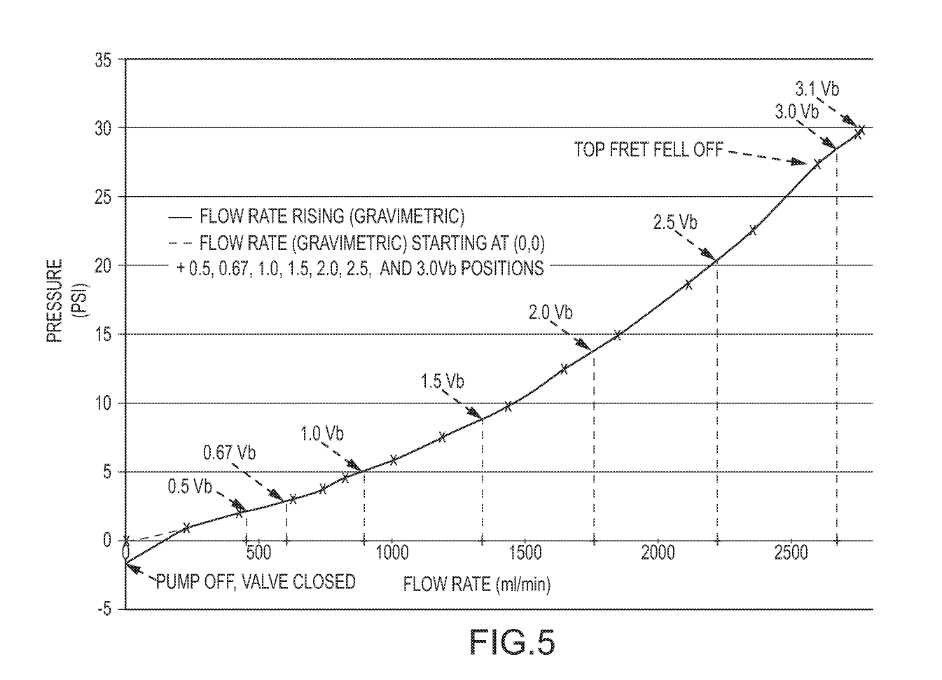

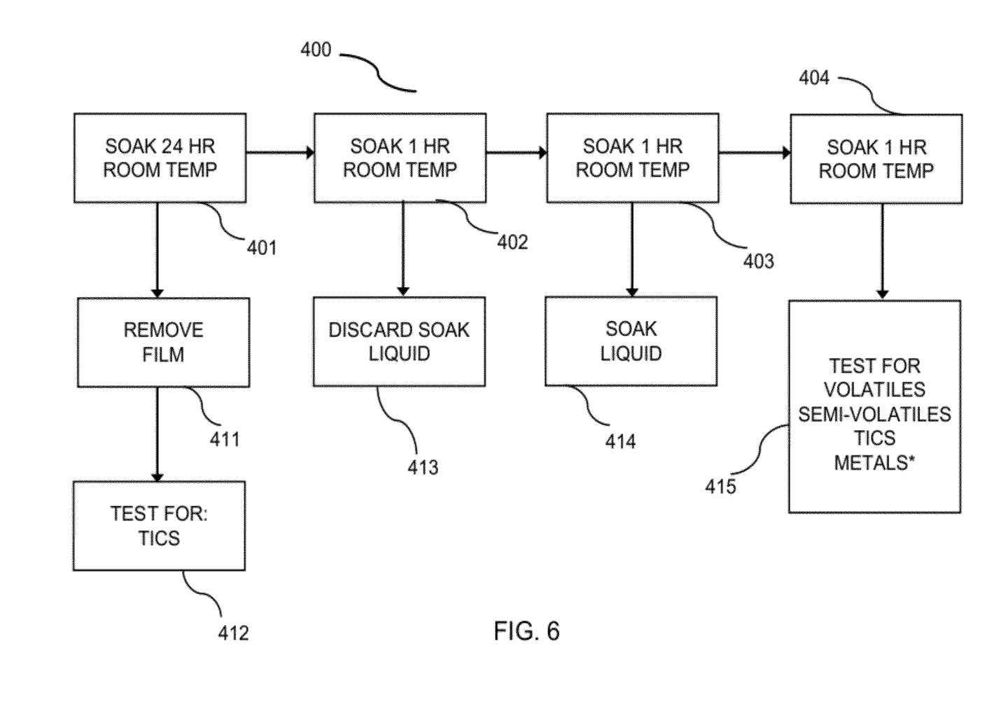

FIG. 6 depicts a modified NSF-61 testing procedure 400. In step 401, the polymeric binder film is pre-conditioned by soaking at ambient temperature in the test water for about a twenty-four hour period. In step 411, the polymeric film is removed from the conditioning liquid. In step 412, the conditioning liquid of step 411 is analyzed for Volatile Organic Compounds per EPA 524.2 and Semi-Volatile Organic Components per EPA 625. These two protocols together measure the quantities found form a list of about 100 compounds, having specific reporting limits, typically found in potable water systems and/or released by polymeric materials into potable water systems. In addition to the analysis for standard compounds, the amounts of any organic compounds are noted and tentatively identified based on library of data. These are reported as TICS (tentatively identified compounds) with estimated concentrations.

In step 402, first volume of fresh conditioning liquid is contacted with the polymeric binder film removed from the conditioning liquid in step 411 and soaked at ambient temperature in the first volume of fresh conditioning liquid for one hour. After the one-hour soak period, the first volume of the conditioning liquid is removed, (step 413) and a second volume of fresh conditioning liquid is contacted with the polymeric binder film (step 403). The polymeric binder film is soaked at ambient temperature in the second volume of fresh conditioning liquid for one hour. After this one-hour period, the second volume of the conditioning liquid is removed (step 414) and a third volume of fresh conditioning liquid is contacted with the polymeric binder film (step 404). The polymer binder film is soaked at ambient temperature in the third volume of fresh conditioning liquid for one hour.

After this one-hour period the third volume of conditioning liquid is removed and analyzed for organic volatile and semi-volatile materials, metals and TICS (step 415). Table 3 summarizes the 24-hour and 24-plus-3 hour conditioning liquid soak results. Furthermore, it appears that uncross-linked Aquatec Kynar-acrylic polymeric binder provides for a lower number and/or concentration of TICS than the cross-linked Aquatec Kynar-acrylic polymeric binder.

TABLE 3
Organic Material Released by the Polymeric Binder

| | Crosslinked Binder | Uncrosslinked Binder |
|---|---|---|
| Test | 59-113 | 59-114 |
| Volatile | Below limit except | Below limit except |
| Organics - Std | chloroform* | chloroform* |
| Semivolatile | Below limit | Below limit |
| Organics - Std | | |
| Metals - Std | Not tested | Below limit except three |
| | | at limit Cd, Pb, Sr** |
| TICS - 24 hr soak | 480 ppb of twelve | 30 ppb of four |
| plus 3 hour test | compounds | compounds |
| | not found in influent | not found in influent |
| TICS - 24 hr soak | 3000 ppb various | 2000 ppb various |
| | compounds, | compounds, |
| | half from long chain | half from long chain |
| | alcohol surfactant | alcohol surfactant |

*chloroform in influent, net subtraction over limit,
**net from subtraction of influent value

Further Extraction Testing

The initial extraction testing was carried out using binder films of Aquatec and Aquatec crosslinked with Picassian XL-702. This example includes extraction testing of rare earth-containing agglomerates. Furthermore, the testing will determine the what affect an ethanol wash may have and will include a binder comprising Hycar 26288.

The rare earth-containing agglomerates were prepared as described above. The binder emulsions evaluated were Aquatec, 80:20 Aquatec crosslinked with Picassian XL-702, and Hycar 26288. 10 volume % of the binder emulsion was contacted with the ceria and mixed on a Keyence mixer to form a binder mixture. The binder mixture was extruded through a 381 micron extrusion screen. The strands were dried overnight at about 60 degrees Celsius and then cured, including the non-crosslinkable samples, for about 2 hours at about 120 degrees Celsius. The cured strands were then comminuted and sieved on a Vortisieve fitted with a 600 micron screen, followed another sieving on the Vortisieve fitted with a 425 micron screen. A 325-400 micron fraction of rare earth-containing agglomerates was collected after the Vorrtisieve sieving process.

The 325-400 micron fraction was split into two sets of samples. Each of the first set of samples was rapidly rinsed nine over with tap water over a 300 micron screen to remove any fines. Each of the first set of samples received an additional rapid tap water rinse prior to extraction testing. The rinsed rare earth-containing agglomerates where dried to constant weight, the drying period was typically about 3 to about 4 hours at 85 degrees Celsius.

Each of the second set of samples (each sample consisting of 100 grams the rare earth-containing agglomerates) was washed twice in tap water before being soaked in 200 mL of 70% n-ethanol quiescent solution overnight.

It should be noted that the intent of rapid water rinsing procedures for the first and second set of samples was to remove fines, but not to remove any water extractables. More specifically, the water rinses were conducted to remove fines but allow the rare earth-containing agglomerates to soak in the water.

The 24 hour room temperature water soak followed by three separate one-hour room temperature water soaks were followed as described above for the initial soak testing. However, instead using a 12.5 gram a 62.5 gram was used and soaked in 100 mL of water. The results of the testing are summarized below in Table 4.

TABLE 4

| | 24 hr | 3 × 1 hr |
|---|---|---|
| | extractables | extractables |
| Sample | (μg/L) | (μg/L) |
| Influent water for film tests | 215 | 175 |
| Influent water for agglomerate tests | 0 | 97 |
| Aquatec Film | 2147 | 53 |
| Aquatec Agglomerate (water rinse) | 258 | 13 |
| Aquatec Agglomerate (ethanol rinse) | 44 | 0 |
| Cross-linked Aquatec Film | 2976 | 522 |
| Crosslined Aquatec Agglomerate | 1635 | 209 |
| (water rinse) | | |
| Crosslinked Aquatec Agglomerate | 326 | 9 |
| (ethanol rinse) | | |
| Hycar Agglomerate (water rinse) | 13 | 25 |
| Hycar Agglomerate (ethanol rinse) | 50 | 18 |

### Example 8

Example 8 is an evaluation of various agglomerates prepared with cerium dioxide having an average particle size of in the micron range and of various agglomerations prepared with cerium dioxide having an average particle size in the nanometer range.

The micron range cerium dioxide had an average particle size of about 30 to about 50 microns. More specifically, the micron range cerium dioxide had an average particle size of about 31.17 μm, an average surface area of about 124.41 m²/g, an average pore volume of about 0.06 cm³/g and an average pore size of about 2.86 nm. Visually, the micron range cerium dioxide had a bright yellow color. Moreover, the micron range cerium dioxide was a Molycorp ceria produced on Oct. 16, 2010 according to standard Molycorp ceria production procedures. The pore volume, pore size, particle size, and loss on ignition values for the micron range cerium dioxide are given in Table 5. The pore volume and size values were determined by BJH absorption. The particle size ranges are defined in percentages of 5, 50 and 95% being less than the size given. For example, sample 1 of Table 4 shows that only 5% of the ceria powder has a size less than about 6.5 microns. The loss on ignition values were determined by calcining at 1000 degrees Celsius. The, respective, percent loss of water and carbonate are calculated from mass loss before and after calcining

TABLE 5

| | Surface | Pore | Pore | | | | Total | | |
|---|---|---|---|---|---|---|---|---|---|
| | Area | Volume† | Size† | Particle Size (μm) | | | LOI | % H₂O | % CO₃ |
| Sample | (m2/g) | (cm3/g) | (nm) | 5% | 50% | 95% | (%) | LOI* | LOI* |
| 1 | 113.87 | 0.057 | 4.83 | 6.5 | 28.98 | 64.64 | 5.33 | 2.82 | 2.45 |
| | 123.3 | 0.058 | 4.95 | — | — | — | — | — | — |
| 2 | 116.97 | 0.056 | 5.08 | 5.69 | 26.84 | 63.17 | 5.20 | 2.68 | 2.45 |
| | 114.6 | 0.055 | 5.03 | — | — | — | — | — | — |
| 3 | 126.08 | 0.065 | 4.87 | 6.38 | 29.03 | 64.85 | 5.63 | 2.80 | 2.72 |
| | 120 | 0.056 | 4.70 | — | — | — | — | — | — |

†average value as determined by BJH Absorption
*estimated value

The nanometer cerium dioxide had an average particle size of no more than about 25 nm. More specifically, the nanometer cerium dioxide had an average surface area of above 35.7 m²/g, an average pore volume of about 0.18 cm³/g and an average pore size of about 17.80 nm. Visually, the nanometer cerium dioxide had a pale yellow color. The nanometer cerium dioxide was purchased from Sigma Aldrich, Lot MKBD9646V. However, it should be noted that the larger pore volume and pore size of the nanometer cerium dioxide is questionable because the nanometer particles may be too small to give accurate pore volume and pore size determinations according to the measurement procedures utilized.

Extrusion Process

Tables 5 and 6 describe amounts of Kynar™ Aquatech 10206 (47 wt % solids) and Picassian™ XL-702 (40 wt % solids) added to distilled water in a 250 mL cup to form a polymeric binder solution. Kynar™ Aquatech 10206 is an aqueous solution of a PVDF-acrylic polymeric composition sold by Arkema. Picassian™ XL-702 is an aqueous solution of a poly-carbodiimide acrylic cross-linker sold by Picassian™. The polymeric binder composition comprises the PVDF-acrylic polymer and the poly-carbodiimide acrylic cross-linker compositions. Half of the mass of ceria particles indicated in Tables 6 and 7 was added with hand mixing to the polymeric binder solution to form a first mixture. The first mixture was mixed by hand until substantially all of the ceria particles were wetted with the polymeric binder solution. After substantially all of the ceria particles were wetted, the first mixture was placed in a Keyence™ HM501 hybrid mixer and the first mixture was mixed for about a 30 second period. After the 30-second mixing period in the HM501 mixer, the first mixture was removed from the HM501 hybrid mixer and returned to the 250 mL cup. The second half of the ceria particles was added the first mixture to form a second mixture. The second mixture was hand mixed to substantially wet all of the ceria particles in the second mixture with the polymeric binder solution. After substantially wetting all of the ceria in the second mixture, the second mixture was placed in the Keyence™ HM501 hybrid mixer and mixed for about a 30-second period to form a paste.

TABLE 6

| | | | |
|---|---|---|---|
| BM66- | 57-1 | 57-2 | 57-3 |

| | | | | | | |
|---|---|---|---|---|---|---|
| Xorbx ™ Ceria | 65.6 | g | 64.18 | g | 62.74 | g |
| Aquatic 10206 [symbol] | 1.82 | g | 2.26 | g | 2.72 | g |
| XL-702 [symbol] | 0.54 | g | 0.68 | g | 0.82 | g |
| Water (distilled) | 18 | ml | 18 | ml | 17 | ml |

*Aquatic is 47% solids, XL-702 is 40% solids [symbol]
mass is mass of substance on dry basis

TABLE 7

| | | | |
|---|---|---|---|
| BM63- | 96-1 | 96-2 | 96-3 |

| | | | | | | |
|---|---|---|---|---|---|---|
| Nano-crystalline ceria | 65.6 | g | 64.18 | g | 62.74 | g |
| Aquatic 10206 [symbol] | 1.82 | g | 2.26 | g | 2.72 | g |
| XL-702 [symbol] | 0.54 | g | 0.68 | g | 0.82 | g |
| Water (distilled) | 18 | ml | 18 | ml | 17 | ml |

*Aquatic is 47% solids, XL-702 is 40% solids [symbol]
mass is mass of substance on dry basis

The paste was charged to a Fuji-Paudal KAR-75 granulator equipped with an extrusion screen having 381 μm diameter orifices. The paste was extruded, under pressure to form an extrudate. The extrudate was in the form of a cylindrical-shaped strand. The extrudate was extruded into a hot circulating airflow having a temperature from about 60 to 70 degrees Celsius. A mandrel assisted the extrusion of the paste through the extrusion screen.

The extrudate was collected and dried for about sixteen hours in an oven at a temperature of about 60 degrees Fahrenheit to form a dried extrudate. The dried extrudate was heated to and maintained for about 2 hours at a temperature of about 120 degrees Celsius to substantially cure the polymeric binder composition and form cured extrudate strands. The cured extrudate strands comprising the micron range cerium dioxide visually had a yellow-brown color, while the cured extrudate comprising the nanometer cerium dioxide visually had a more tan/brown in color.

The cured extrudate strands were charged to a model RBF10 Vorti-Siv shaker equipped with a 10-inch diameter screen having 600 μm square pattern orifices (which corresponds to about a 30-mesh size screen) and a rotating nylon brush. The cured extrudate strands were broken by the shaker. The broken strands passing through the 600 μm square pattern orifices formed a first broken-batch of strands. The first broken batch of strands was charged to the Vorti-Siv shaker, equipped with a 10-inch diameter screen having 425 μm square pattern orifices (which corresponds to about a 40-mesh size screen). The strands passing through the 425 μm square pattern orifices formed a second-broken batch of strands.

The second-broken batch of strands was manually sieved in a stack of Tyler mesh screens arranged in a top to down order of 425, 300, 180 and 106 μm (with the 425 μm screen at the top and the 106 μm screen at the bottom). The second-broken batch of strands was charged to the 425 μm screen. After manually sieving the second-broken batch of strands, broken strands retained by each of the 425, 300, 180 and 106 μm Tyler mesh screens were collected and weighted separately. Table 8 summarizes the collected data. At least most of the mass of the second-broken batch of strands has a size from about 300 to about 425 μm.

TABLE 8

| Agglomerate Initial Sieve Results | | | % Yield of Each Fraction | | | |
|---|---|---|---|---|---|---|
| Sample ID | Media | Process | 300-425 μm | 180-300 μm | 106-180 μm | <106 μm |
| BM63-96-1 | Nano | Extrusion | 76.75 | 18.19 | 2.38 | 2.68 |
| BM66-57-1 | Xsorbx ™ | Extrusion | 87.94 | 4.75 | 1.01 | 6.3 |
| BM63-96-2 | Nano | Extrusion | 81.31 | 12.73 | 2.73 | 3.23 |
| BM66-57-2 | Xsorbx ™ | Extrusion | 88.67 | 4.22 | 1.08 | 6.03 |
| BM63-96-3 | Nano | Extrusion | 86.73 | 9.88 | 1.41 | 1.98 |
| BM66-57-3 | Xsorbx ™ | Extrusion | 88.13 | 3.74 | 1.51 | 6.62 |

A packing density determination was made for each sample the second-broken batch of strands having a size from about 300 to about 425 μm. A given mass of each formulation having a size from about 300 to about 425 μm was charged to a graduate cylinder. After charging the cylinder, the cylinder was gently tapped until particle settling appeared to stop, at which point the volume of settled particles was recorded. The packing density is the ratio of mass of particles charged to the graduate cylinder divided by settled particle volume. Table 9 summarizes the packing density data for various agglomerate cerium dioxide formulations.

TABLE 9
Tap Density 300-425 μm Fraction

| Sample ID | Media | Process | Tap Density g/cc |
|---|---|---|---|
| BM63-96-1 | Nano | Extrusion | 1.471 |
| BM66-57-1 | Xsorbx | Extrusion | 1.317 |
| BM63-96-2 | Nano | Extrusion | 1.517 |
| BM66-57-2 | Xsorbx | Extrusion | 1.252 |
| BM63-96-3 | Nano | Extrusion | 1.471 |
| BM66-57-3 | Xsorbx | Extrusion | 1.252 |

Comparative strengths of the formulations in Tables 6 and 7 were determined by measuring fine particle content. Stronger formulations were expected to have smaller fine particle content than weaker formulations. Methods A, B and C were used to measure fine particle content.

Method A

About 0.5 grams of each formulation having a size from about 300 to about 425 μm (hereinafter referred to in this section as “the sample”) was charged to a scintillation vial. The total mass of the sample and scintillation vial is recorded. After recording the total mass, about 20 mL of distilled water was charged to the scintillation vial, the scintillation vial was then sealed, placed an ultrasonic bath (Branson 220) and subjected to ultrasonic energy for about a three-minute period. After the three-minute period of applying ultrasonic energy, the scintillation vial was removed from the ultrasonic bath and the vial was swirled to suspend the fine particles in the water. While the fine particles were suspended in the water, at least most of the fine particles and water was removed from the scintillation vial by pipette. The scintillation vial and the sample (less the removed fines) were dried at a temperature of about 100 degrees Celsius to a constant mass. The difference between total mass (of the sample and scintillation vial) and the constant mass dried to (after removing the fine particles and water by pipette) corresponds to the mass of the fine particles contained in the sample.

Method B

This method is the same as Method A except 2 grams of each formulation having a size from about 300 to about 425 μm is charged to a scintillation vial instead of 0.5 grams. It is believed that taking about 2 grams, instead of 0.5 grams, improves both the accuracy and precision in determining the mass of fine particles contained in the sample.

Method C

About 0.5 grams of each formulation having a size from about 300 to about 425 μm (hereinafter referred to in this section as “the sample”) was charged to a scintillation vial. The mass of the sample charged to the scintillation vial was recorded to 0.1 mg. After recording the mass of the sample, about 20 mL of distilled water was charged to the scintillation vial. After charging the water to scintillation vial, the vial was sealed, placed in an ultrasonic bath and subjected to ultrasonic energy for about a three-minute period. After the three-minute period, the water was decanted from the sample. The sample was dried at temperature of about 100 degrees Celsius to constant weight. The dried sample is sieved using a 180 micron screen. The mass of the sample retained by the 180 micron screen was determined. The difference in mass of the sample charged to scintillation vial and the sample retained by the 180 micron screen corresponds to the mass of the sample comprising particles smaller than about 180 microns.

Table 10 summarizes the fine particle content determine for each formulation by each of Methods A, B and C. In general, agglomerations having nano-crystalline cerium dioxide particles had less fine particles, that is the nano-crystalline agglomerates are stronger, than agglomerates having micron cerium dioxide particles.

Method D

Yet another method for measuring fine content includes charging about 0.5 grams of an agglomerated sample to a scintillation vial. The weight of the agglomerate sample is recorded. About 20 mL of distilled water is added to the vial. After adding the water, the vial is sealed and placed in an ultrasonic bath and subjected to ultrasonic energy for about a three-minute period, after which the aqueous phase is decanted. The turbidity of the aqueous is determined using a standard turbidity meter, such as, an Oakton turbidity meter.

Turbidity is a measure of the cloudiness and/or haziness of a fluid. The cloudiness is typically caused by particles, such as fines, suspended in the aqueous phase. The suspended particles scatter light. Generally, the greater the amount of light scattered at a given angle from the light source beam the greater the number and/or the smaller the size of suspended particles and the greater the turbidity of the aqueous sample. It can be appreciated that the amount of light scattered by the particles depends on the physical properties of the particles. For example, size, shape, color and reflectance of the particle typically affects the amount of light scattered by the particle. Units of turbidity, when measured by light scattering, are NTU (for nephelometric turbidity units).

When determining the fine content of various agglomerated samples, it is preferred to applying the ultrasonic energy to the each sample under about the same conditions of: placement in the ultrasonic bath, application of about the same level of ultrasonic energy and application of the ultrasonic energy for about the same period of time. Differences in one or more of these conditions can negatively affect the accuracy and precession of the measurement.

TABLE 10
Agglomerate Granule Strength 300-425 μm Fraction

| | | | Loss | Loss | Loss |
|---|---|---|---|---|---|
| | | | mg/g, | mg/g, | mg/g, |
| Sample ID | Media | Process | Method B | Method C | Method A |
| BM63-96-1 | Nano | Extrusion | 9.9 | 16.6 | 47.7 |
| BM66-57-1 | Xsorbx ™ | Extrusion | 29.8 | 31.0 | |
| BM63-96-2 | Nano | Extrusion | 8.8 | 14.9 | 23.9 |
| BM66-57-2 | Xsorbx ™ | Extrusion | 17.9 | 29.5 | |
| BM63-96-3 | Nano | Extrusion | 9.1 | 13.7 | 22.1 |
| BM66-57-3 | Xsorbx ™ | Extrusion | 125.3 | 29.1 | |

Capacity Studies

The capacities for arsenic removal for a micron range cerium dioxide agglomerate (corresponding to Sample BM63-96-1 of Table 10) and nanometer range cerium dioxide agglomerate (corresponding to Sample BM66-57-1 of Table 10) were determined. The micron range cerium dioxide agglomerate contained 8 volume % of carbodiimide cross-linked polyvinylidene fluoride-acrylic binder. The nanometer range cerium dioxide agglomerate contained 10 volume % of carbodiimide cross-linked polyvinylidene fluoride-acrylic binder. The second-broken batch of strands having a size from about 300 to about 425 μm for each of the micron range cerium dioxide and nanometer range cerium dioxide agglomerates (hereinafter within this capacity studies section is referred to as “media”) were used in this capacity study. Table 11 summarizes the characteristics of the media.

TABLE 11

| | Particle | Surface | Pore | Pore | Tap | |
|---|---|---|---|---|---|---|
| | Size | Area | Volume | Size | Density | wt % |
| Media | (μm) | (m²/g) | (cm³/g) | (nm) | (g/mL) | Polymer |
| Molycorp HSA | 31.17 | 124.4 | 0.06 | 2.86 | 1.16 | — |
| Ceria Powder | | | | | | |
| Agglomerated | 300-425 | 100.5 | 0.057 | 5.39 | 1.33 | 2.03 |
| Molycorp HSA | | | | | | |
| Ceria Powder | | | | | | |
| Nano-Crystalline | <0.025 | 35.8 | 0.18 | 17.80 | 0.38 | — |
| Ceria Powder | | | | | | |
| Agglomerated | 300-425 | 32.2 | 0.191 | 18.17 | 1.67 | 2.03 |
| Nano-Crystalline | | | | | | |
| Ceria Powder | | | | | | |

For each of the micron range cerium dioxide and the nanometer range cerium dioxide agglomerates, about 45 mL of the media was charged to a graduated cylinder. After charging the graduated cylinder, the media was packed by gently tapping the cylinder. The volume of the packed media was recorded. The media was transferred to a glass vacuum flask and 100 mL deionized water was charged to the vacuum flask to form an aqueous slurry of the media. The vacuum flask was sealed, the pressure within the flask was reduced using a vacuum pump, and the vacuum flask was swirled by hand to substantially submerge and wet the media. The media was soaked in the deionized water for about 30 minutes. After the 30-minute soaking period, the deionized water was decanted. The soaking and decanting of the media was repeated until the decanted water was substantially free of fine particles to form a fine-free media. Typically the decanted water was substantially free of fine particles after about four soak/decant cycles.

The fine-free media was mixed with deionized water to form a fine-free slurry. The fine-free media slurry was charged to a one-inch internal diameter column configured according to the column set-up 300, described above. The fine-free media was packed in the column 301 in the form of an aqueous slurry prepared with deionized water. After the 5-minute setting period, deionized water was flowed through the column to further settling the media. After which, the deionized water in column 301 above the media bed 303, within tank line 311, and, in in-put line 312 was removed and replaced with an NSF-53 solution, see Table 12 for composition of the NSF-53 solution. The pH of the NSF-53 solution was adjusted to pH 7.5 with 1 N NaOH and/or 0.3 N HCl.

TABLE 12

| Regent | Concentration (mg/L) |
|---|---|
| Sodium Silicate | 93.00 |
| Sodium Bicarbonate | 250.00 |
| Magnesium Sulfate | 128.00 |
| Sodium Nitrate | 12.00 |
| Sodium Fluoride | 2.20 |
| Sodium Phosphate | 0.18 |
| Calcium Chloride | 111.00 |
| Arsenate (As V) | 0.30 |

About every hour of operation, the collector 304 collected a 10 mL sample of the effluent. The collected effluent sample was analyzed for arsenic using inductively coupled plasma-mass spectrometry. The column set-up was operated continuously until 50 μg/L or more of arsenic (V) was detected in the effluent.

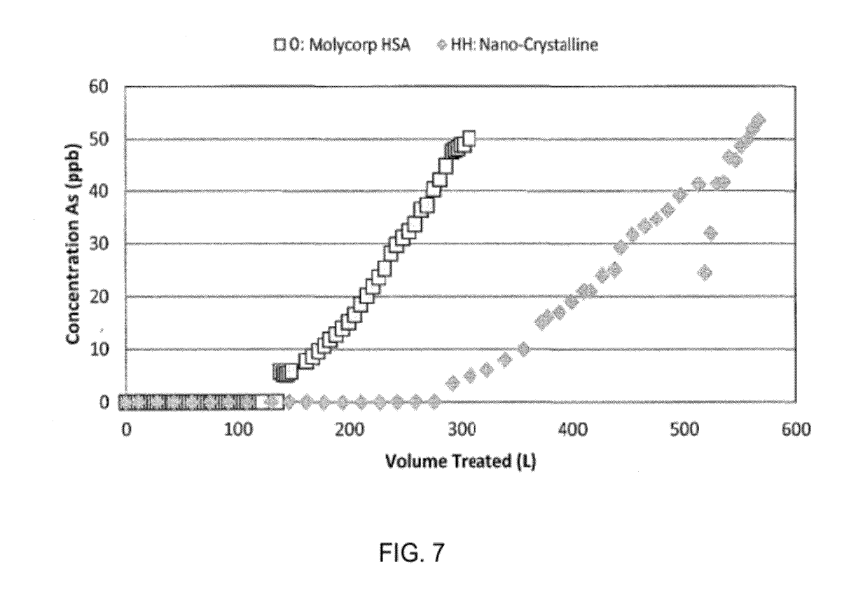

FIG. 7 and Table 13 summarize the capacity study results. The micron range cerium dioxide agglomerated media reached the 50 μg/L arsenic breakthrough value after treating about 307 L of the arsenic (V)-containing NSF-53 solution, while the nanometer range cerium dioxide Agglomerated media treated about 561 L before reaching the 50 μg/L arsenic breakthrough value. This correlates to arsenic capacity values of 1.53 mg As/g media for the micron range ceria agglomerate and 2.19 mg As/g media for the nanometer range ceria agglomerate. Moreover, the capacities for micron range and nanometer range ceria to remove arsenic are, respectively, 1.57 and 2.23 mg/ceria.

TABLE 13

| | Volume | | | |
|---|---|---|---|---|
| | 50 μg/L | Mass | Capacity | Capacity |
| | Break- | Media | by Mass | by Mass |
| Media | through | Used | Media | Ceria Only |
| Molycorp HSA | 307 L | 57.38 g | 1.53 mg As/g | 1.57 mg As/g |
| Agglomerated | | | Media | CeO₂ |
| Ceria | | | | |
| Nano-Crystalline | 561 L | 75.09 g | 2.19 mg As/g | 2.23 mg As/g |
| Agglomerated | | | Media | CeO₂ |
| Ceria | | | | |

### Example 9

Rare earth-containing agglomerates were made by a process in which the binder emulsion and ceria were mixed to form a paste consistency by a hybrid shear mixer Keyence HM-501. The binder was fed into an extruder and extruded into strands having a length of more than 2 mm. The extruder was a Fuji Paudal basket, twin dome, or radial extruder. The extruded strands were dried and, depending on the binder, optionally cured. The dried and/or cured strands were vibrated and broken into particles approaching a 1:1 aspect ratio (relative to strand diameter as determined by extrusion screen orifice size). The strands were broken by vibration or by addition of media such as nylon brushes or ceramic balls to vibration process. The particles were classified and evaluated, see Table 14 for a summary of the results.

TABLE 14

| Binder | | | Approx. | Approx. | |
|---|---|---|---|---|---|
| Reference | | | Vol. % | Size, | |
| Number | Type | Grade | Range | μm | Result |
| BM53-133-1 | XL fluoropolymer | Aquatec | 15 | 600-825 | Excellent str; |
| BM53-161-1 | | 30%/XL-702 | | | low capacity |
| BM53-174-1-3 | XL fluoropolymer | Aquatec | 10-15 | 600-825 | Excellent |
| | | 30%/XL-702 | | | strength |
| BM53-172-1 | Fluoropolymer | Aquatec | 15 | 600-850 | Good strength |
| | | 30% acrylic | | | |
| BM53-172-2 | Fluoropolymer | Aquatec | 15 | 600-850 | Fair strength |
| | | 50% acrylic | | | |
| BM53-172-3 | Polyurethane | Picassian PU | 15 | 600-850 | Fair str; poor |
| | | 429 | | | wetting |
| BM53-175-1 | Polyvinylalcohol* | Mowiol 56-98 | 15 | 600-850 | Poor str |
| BM53-175-2 | XL Ethylene Vinyl | Dur-O-Set | 15 | 600-850 | Poor str |
| | Acetate | 351/XL702 | | | |
| BM53-185-1 | XL fluoropolymer | Aquatec | 10 | 600-850 | Good capacity |
| | | 30%/XL-702 | | | |
| BM53-186-1 | Polyvinylalcohol* | Mowiol 56-98 | 12 | 600-850 | Poor capacity |
| | | | | | (swelling?) |
| BM63-08 | XL fluoropolymer | Aquatec | 10 | 425-600 | Good capacity |
| | | 30%/XL-702 | | | |
| BM63-16 | XL fluoropolymer | Aquatec | 10 | 300-425 | V. good |
| | | 30%/XL-702 | | | capacity |
| BM63-54-1 | Ethylene Vinyl | Dur-O-Set | 10 | 300-425 | V. good |
| | Acetate | E200 | | | capacity |
| BM66-25-1 | Acrylic | HYCAR 26288 | 10 | 300-425 | V. good |
| | | | | | capacity |
| BM66-39-1 | Acrylic | HYCAR 26288 | 10 | 425-600 | Fair capacity |
| BM66-25-2 | Fluoropolymer | Aquatec 10206 | 10 | 300-425 | — |
| | | Not XL | | | |
| BM66-25-3 | Vinyl Cl | VYCAR | 10 | 300-425 | — |
| | copolymer | 660X14 | | | |
| BM66-various | Polyvinylidene | Serfene 400, | 10-18 | 425-600 | Poor strength |
| | chloride | Serfene 2022 | | | |

*case of binder dissolved in carrier fluid; rest are all emulsion systems
XL = crosslinked
Aquatec 30% is Aquatec 10206 ™ or comerically Aquatec ARC ™
Aquatec 50% acrylic is Aquatec 102044 ™

### Example 10

### Sintered Agglomerates

Sintered agglomerates having the fluoropolymer binder were prepared by mixing 90 volume % of the respective cerium dioxide powder with 10 volume % of the Kynar Flex 2821 fluoropolymer to form a polymeric mixture. The polymeric mixture was charged to a die and compacted at a temperature of about 25 degrees Celsius and pressure of about 5,000 psi for about 3 minutes to for a compacted polymeric mixture.

Typically, the sintered block would break into a plurality of fragments and/or chucks during removal from the sintering frame. The plurality of fragments and/or chucks commonly ranged in size from about 1 to about 10 mm. The plurality of fragments and/or chucks were subjected to the fine content protocol of Example 8, Method A. While not wanting to be bound by example, it appears having a binder is better than lacking a binder (see Table 15). However, comparing sintering to agglomeration and/or between sintered and/or agglomerated micron and nanoparticles may be problematic.

TABLE 15
Sintered Block

| | Kynarflex | | | Loss mg/g, |
|---|---|---|---|---|
| Sample ID | Vol % | Media | Process | Method A |
| BM63-97-1 | 0 | Nano | Sinter - 5000 psi | 70.6 |
| BM63-116-1 | 0 | Xorbx | Sinter - 5000 psi | 58.0 |
| BM63-97-2 | 10 | Nano | Sinter - 5000 psi | 8.8 |
| BM63-116-2 | 10 | Xorx | Sinter - 5000 psi | 19.6 |

Vol % refers to volume percent of Knyarflex emulsion contacted with the media; 0 vol % Knyarflex refers to sintering and compaction with a polymeric binder

### Example 11

### Contaminant Removal Examples

Chemical Contaminants

ABS plastic filter housings (1.25 inches in diameter and 2.0 inches in length) were packed with ceric oxide (CeO₂) that was prepared from the thermal decomposition of 99% cerium carbonate. The housings were sealed and attached to pumps for pumping an aqueous solution through the housings. The aqueous solutions were pumped through the material at flow rates of 50 and 75 ml/min. A gas chromatograph was used to measure the final content of the chemical contaminant. The chemical contaminants tested, their initial concentration in the aqueous solutions, and the percentage removed from solution are presented in Table 16.

TABLE 16

| | | Starting | % | % |
|---|---|---|---|---|
| | | concentration | Removal at | Removal at |
| Common Name | Chemical Name | (mg/L) | 50 mL/min | 75 mL/min |
| VX | O-ethyl-S-(2- | 3.0 | 99% | 97% |
| | isopropylaminoethyl) | | | |
| | methyphosphonothiolate | | | |
| GB (sarin) | Isopropyl | 3.0 | 99.9% | 99.7% |
| | methylphosphonofluoridate | | | |
| HD (mustard) | Bis(2-chloroethyl)sulfide | 3.0 | 92% | 94% |
| Methamidophos | O,S-dimethyl | 0.184 | 95% | 84% |
| | phosphoramidothioate | | | |
| Monochrotophos | Dimethyl (1E)-1-methyl-3- | 0.231 | 100% | 100% |
| | (methylamion)-3-oxo-1- | | | |
| | propenyl phosphate | | | |
| Phosphamidion | 2-choloro-3- | 0.205 | 100% | 95% |
| | (diethylamino)-1-methyl-3- | | | |
| | oxo-1-prpenyl dimethyl | | | |
| | phosphate | | | |

Biological Contaminants

15 ml of CeO₂ obtained from Molycorp, Inc.'s Mountain Pass facility was placed in a 7/8″ inner diameter column.

600 ml of influent containing de-chlorinated water and 3.5×10⁴/ml of MS-2 was flowed through the bed of CeO₂ at flow rates of 6 ml/min, 10 ml/min and 20 ml/min. Serial dilutions and plating were performed within 5 minutes of sampling using the double agar layer method with E. Coli, host and allowed to incubate for 24 hrs at 37° C. The results of these samples are presented in Table 17.

TABLE 17

| Bed and Flow | Influent | Effluent | % | |
|---|---|---|---|---|
| Rate | Pop./mL | Pop./mL | Reduction | Challenger |
| CeO₂ 6 mL/min | 3.5 × 10⁴ | 1 × 10⁰ | 99.99 | MS-2 |
| CeO₂ 10 mL/min | 3.5 × 10⁴ | 1 × 10⁰ | 99.99 | MS-2 |
| CeO₂ 20 mL/min | 3.5 × 10⁴ | 1 × 10⁰ | 99.99 | MS-2 |

The CeO₂ bed treated with the MS-2 containing solution was upflushed. A solution of about 600 ml of de-chlorinated water and 2.0×10⁶/ml of Klebsiella terrgena was prepared and directed through the column at flow rates of 10 ml/min, 40 ml/min and 80 ml/min. The Klebsiella was quantified using the Idexx Quantitray and allowing incubation for more than 24 hrs. at 37° C. The results of these samples are presented in Table 18.

TABLE 18

| Bed and Flow | Influent | Effluent | % | |
|---|---|---|---|---|
| Rate | Pop./mL | Pop./mL | Reduction | Challenger |
| CeO₂ 10 mL/min | 2.0 × 10⁶ | 1 × 10⁻² | 99.99 | Klebsilla |
| CeO₂ 40 mL/min | 2.0 × 10⁶ | 1 × 10⁻² | 99.99 | Klebsilla |
| CeO₂ 80 mL/min | 2.0 × 10⁶ | 1 × 10⁻² | 99.99 | Klebsilla |

The CeO₂ bed previously challenged with MS-2 and Klebsiella terrgena was then challenged with a second challenge of MS-2 at increased flow rates. A solution of about 1000 ml de-chlorinated water aid 2.2×10⁵/ml of MS-2 was prepared and directed through the bed at flow rates of 80 ml/min, 120 ml/min and 200 ml/min. Serial dilutions and plating were performed within 5 minutes of sampling using the double agar layer method with E. Coli host and allowed to incubate for 24 hrs at 37° C. The results of these samples are presented in Table 19.

TABLE 19

| Bed and Flow | Influent | Effluent | % | |
|---|---|---|---|---|
| Rate | Pop./mL | Pop./mL | Reduction | Challenger |
| CeO₂ 80 mL/min | 2.2 × 10⁵ | 1 × 10⁰ | 99.99 | MS-2 |
| CeO₂ 120 mL/min | 2.2 × 10⁵ | 1.4 × 10² | 99.93 | MS-2 |
| CeO₂ 200 mL/min | 2.2 × 10⁵ | 5.6 × 10⁴ | 74.54 | MS-2 |

Dye Contaminants

In a first example, twenty 3.6 g packets of cherry Kool-Aid™ unsweetened soft drink mix (containing Red 40 (as azo dye having the composition 2-naphthalenesulfonic acid, 6-hydroxy-5-((2-methoxy-5-methyl-4-sulfophenyl)azo) disodium salt, and disodium 6-hydroxy-5-((2-methoxy-5-methyl-4-sulfophenyl)azo)-2-naphthalenesulfonate) and Blue 1 (a disodium salt having the formula C₃₇H₃₄N₂Na₂O₉S₃) dyes) were added to and mixed with five gallons of water. For use in the first test, a column setup was configured such that the dyed water stream enters and passes through a fixed bed of insoluble cerium (IV) oxide to form a treated solution. The dyed, colored water was pumped through the column setup. The treated solution was clear of any dyes, and at the top of the bed there was a concentrated band of color, which appeared to be the Red 40 and Blue 1 dyes.

In a second example, cherry Kool-Aid™ unsweetened soft drink mix (containing Red 40 and Blue 1 dyes) was dissolved in water, and the mixture stirred in a beaker. Insoluble cerium (IV) oxide was added and kept suspended in the solution by stirring. When stirring ceased, the cerium oxide settled, leaving behind clear, or colorless, water. This example is intended to replicate water treatment by a continuous stirred tank reactor (CSTR).

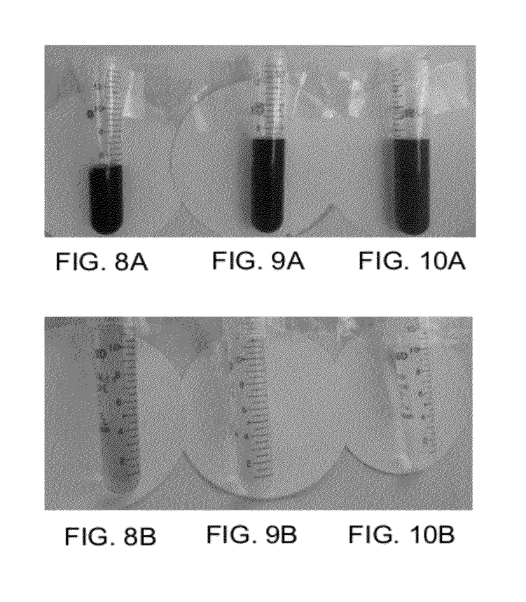

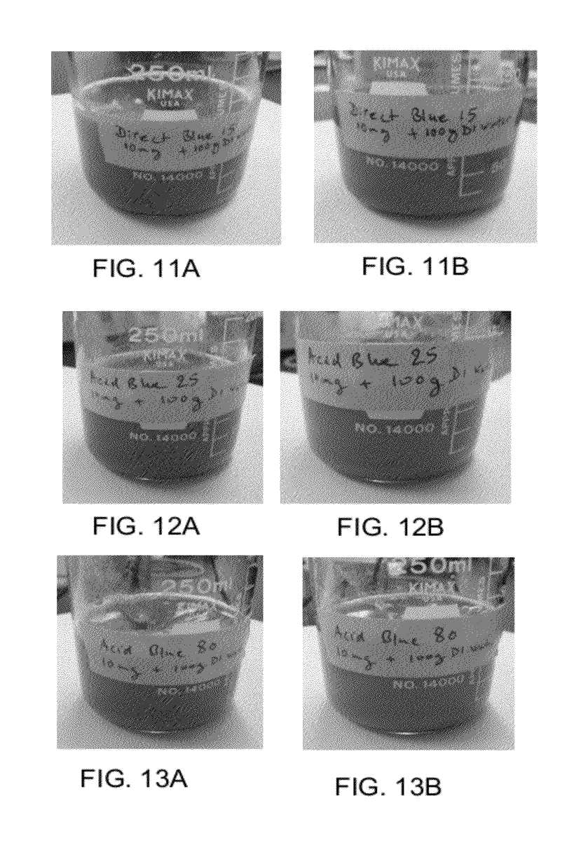

In a third example, 10.6 mg of Direct Blue 15 (C₃₄H₂₄N₆Na₄O₁₆S₄, from Sigma-Aldrich) was dissolved in 100.5 g of de-ionized water. The Direct Blue 15 solution (FIG. 8A) was stirred for 5 min. using a magnetic stir bar before adding 5.0012 g of high surface area ceria (CeO₂). The ceria-containing Direct Blue 15 solution was stirred. The ceria-containing Direct Blue 15 solution 2 min and 10 min after adding the ceria are, respectively, showed in FIGS. 11A and 11B. After stirring for 10 min, a filtrate was extracted using a 0.2 μm syringe filter. The filtrate was clear and substantially colorless, having a slightly visible blue tint (FIG. 8B).

In a fourth example, 9.8 mg of Acid Blue 25 (45% dye content, C₂₀H₁₃N₂NaO₅S, from Sigma-Aldrich) was dissolved in 100.3 g of de-ionized water. The Acid Blue 25 solution (FIG. 9A) was stirred for 5 min. using a magnetic stir bar before adding 5.0015 g of high surface area ceria (CeO₂). The ceria-containing Acid Blue 25 solution was stirred. The ceria-containing Acid Blue 25 solution 2 min and 10 min after adding the ceria are, respectively, showed in FIGS. 12A and 12B. After stirring for 10 min, a filtrate was extracted using a 0.2 μm syringe filter. The filtrate was clear and substantially colorless, and lacked any visible tint (FIG. 9B).

In a fifth example, 9.9 mg of Acid Blue 80 (45% dye content, C₃₂H₂₈N₂Na₂O₈S₂, from Sigma-Aldrich) was dissolved in 100.05 g of de-ionized water. The Acid Blue 80 solution (FIG. 10A) was stirred for 5 min. using a magnetic stir bar before adding 5.0012 g of high surface area ceria (CeO₂). The ceria-containing Acid Blue 80 solution was stirred. The ceria-containing Acid Blue 80 solution 2 min and 10 min after adding the ceria are, respectively, showed in FIGS. 13A and 13B. After stirring for 10 min, a filtrate was extracted using a 0.2 μm syringe filter. The filtrate was clear and substantially colorless, and lacked any visible tint (FIG. 10B).

Based on these experiments and while not wishing to be bound by any theory, the dyes are believed to sorb or otherwise react with the cerium (IV) oxide.

A number of variations and modifications of the disclosure can be used. It would be possible to provide for some features of the disclosure without providing others.

The present disclosure, in various embodiments, configurations, or aspects, includes components, methods, processes, systems and/or apparatus substantially as depicted and described herein, including various embodiments, configurations, aspects, sub-combinations, and subsets thereof. Those of skill in the art will understand how to make and use the various embodiments, configurations, or aspects after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that any claim and/or combination of claims require more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment.

Moreover, though the description of the disclosure has included descriptions of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method, comprising:
contacting particles containing a friable metal oxide with a binder emulsion containing a polymeric material to form a cohesive binder mixture; and
extruding the binder mixture to form metal oxide-containing agglomerates comprising the polymeric material and the particles containing the rare earth oxide.

2. The method of claim 1, wherein the binder mixture comprises from about 0.1 to about 5 wt % of the polymeric material and from about 50 to 90 wt % of the friable metal oxide with the remainder being water, wherein the binder mixture is extruded through one of a screen or die into an air stream having a temperature from about 50 degrees Fahrenheit to about 140 degrees Fahrenheit to form an extrudate.

3. The method of claim 2, further comprising one or both of:
drying the extrudate at a temperature of no more than about 100 degrees Celsius; and
cross-linking the polymeric material.

4. The method of claim 3, wherein the cross-linking includes one or more of:
curing at a temperature of from about 20 degrees Celsius to about 200 degrees Celsius;
applying ultra-violet energy;
applying an electron beam;
initiating cross-linking with a cationic initiator;
initiating cross-linking with anionic initiator; and
initiating cross-linking with a free radical initiator.

5. The method of claim 2, wherein the friable metal oxide is a rare earth oxide, further comprising:
forming the agglomerates by comminuting the extrudate, wherein the metal oxide-containing agglomerates have an aspect ratio of metal oxide-containing agglomerate length to metal oxide-containing agglomerate width of from about 0.5:1 to about 5:1.

6. The method of claim 1, wherein the friable metal oxide particles comprise primarily cerium dioxide, wherein the binder emulsion is an aqueous polyacrylate emulsion.

7. The method of claim 1, wherein the binder emulsion comprises from about 35 to about 75 wt % solids and wherein the metal oxide-containing agglomerates comprise from about 0.5 wt % to about 5 wt % of the polymeric material.

8. The method of claim 1, wherein the friable metal oxide is a rare earth oxide, wherein the rare earth oxide is in the form of particles having:
a mean, median, and/or P₉₀ size of about 1 micron or more;
a mean and/or median surface area of from about 50 to about 250 m²/g;
a mean and/or median pore volume of from about 0.01 to about 0.1 cm³/g; and
a mean and/or median pore size of from about 1 to about 10 nm.

9. The method of claim 1, wherein the friable metal oxide is a rare earth oxide, wherein the rare earth oxide is in the form of particles having:
a mean, median, and/or P₉₀ size of less than about 1 micron;
a mean and/or median surface area of from about 5 to about 80 m²/g;
a mean and/or median pore volume of from about 0.01 to about 1 cm³/g; and
a mean and/or median pore size of from about 5 to about 30 nm.

10. The method of claim 2, wherein the metal oxide-containing agglomerates have:
a mean and/or median pore size from about 1 to about 30 nm;
a mean and/or median pore volume size from about 0.01 to about 1 cm³/g; and
a mean and/or median surface area of from about 5 to about 250 m²/g.

11. The method of claim 1, wherein the metal oxide-containing agglomerates have a mean, median and/or mean P₉₀ size of from about 300 to about 500 microns; and the polymeric material comprises a self-crosslinking polyacrylate.

12. A method, comprising:
contacting friable metal oxide-containing particles with a binder to form a binder mixture; and
extruding the binder mixture to form metal oxide-containing agglomerates, wherein, during extruding, the binder mixture is not heated prior to being forced through a screen or die, wherein a binder mixture temperature increases no more than 10 degrees Celsius when passing through the screen or die.

13. The method of claim 12, wherein the friable metal oxide-containing particles comprise primarily cerium dioxide, wherein the polymeric material comprises a polyacrylate, wherein the metal oxide-containing agglomerates have a length to width aspect ratio of from about 0.5:1 to about 5:1.

14. The method of claim 12, wherein the binder comprises an aqueous emulsion of a polymeric material, wherein the binder emulsion has from about 25 to about 75 wt % solids, wherein an extrudate is formed during extruding, the method further comprising:
comminuting the extrudate to form the metal oxide-containing agglomerates.

15. The method of claim 14, further comprising one or both of:
drying the extrudate; and
curing the extrudate.

16. The method of claim 15, wherein the drying temperature is from about 5 degrees Celsius and about 130 degrees Celsius, wherein the curing includes heating the extruduate to a temperature of from about 20 degrees Celsius to about 200 degrees Celsius.

17. The method of claim 14, wherein the binder comprises a polymeric material, wherein the binder mixture comprises on a dry basis from about 1 to about 20 wt % of the polymeric material and the remainder being the friable metal oxide-containing particles.

18. The method of claim 12, wherein the binder comprises a thermosetting polymeric material, wherein the metal oxide-containing agglomerates have:
a mean and/or median pore size from about 1 to about 30 nm;
a mean and/or median pore volume size from about 0.01 to about 1 cm³/g; and
a mean and/or median surface area of from about 5 to about 250 m²/g.

19. The method of claim 18, wherein the polymeric material comprises a polyacrylate, wherein the polymeric material is substantially C-staged, wherein the friable metal oxide comprises a rare earth oxide, wherein the rare earth oxide comprises particles having:
a mean, median, and/or P₉₀ size of less than about 1 micron.
a mean and/or median surface area of from about 5 to about 80 m²/g;
a mean and/or median pore volume of from about 0.05 to about 0.5 cm³/g; and
a mean and/or median pore size of from about 5 to about 30 nm.

20. The method of claim 18, wherein the polymeric material comprises a polyacrylate, wherein the polymeric material is substantially C-staged, wherein the friable metal oxide comprises a rare earth oxide, wherein the rare earth oxide comprises particles having:
a mean, median, and/or P₉₀ size of least about 1 micron;
a mean and/or median surface area of from about 50 to about 250 m²/g;
a mean and/or median pore volume of from about 0.01 to about 1 cm³/g; and
a mean and/or median pore size of from about 1 to about 15 nm.

21. The method of claim 12, wherein the rare earth-containing agglomerates have a fine content of no more than about 500 NFU.

22. A composition, comprising:
from about 0.5 to about 10 wt % of a thermosetting polymeric material; and
from about 90 to about 99.5 wt % of rare earth oxide-containing particles.

23. The composition of claim 22, wherein the thermosetting polymeric material is substantially a C-staged.

24. The composition of claim 22, wherein the polymeric material comprises a polyacrylate, wherein the rare earth oxide-containing particles contain synthetically prepared cerium dioxide, wherein the rare earth oxide-containing particles have:
a mean, median, and/or P₉₀ size of about 1 micron or more;
a mean and/or median surface area of from about 50 to about 250 m²/g;
a mean and/or median pore volume of from about 0.01 to about 0.1 cm³/g; and
a mean and/or median pore size of from about 1 to about 10 nm.

25. The composition of claim 22, wherein the polymeric material comprises a polyacrylate, wherein the rare earth oxide-containing particles contain synthetically prepared cerium dioxide and have a mean, median, and/or P₉₀ size of less than about 1 micron, where the rare earth and oxide-containing particles have:
a mean and/or median surface area of from about 5 to about 80 m²/g;
a mean and/or median pore volume of from about 0.01 to about 1 cm³/g; and
a mean and/or median pore size of from about 5 to about 30 nm.

26. The composition of claim 22, wherein the composition is in the form of an agglomerate having:
an aspect ratio of agglomerate length to agglomerate width of from about 0.5:1 to about 5:1;
a mean and/or median pore size from about 1 to about 30 nm; and
a mean and/or median pore volume size from about 0.01 to about 1 cm³/g; and
a mean and/or median surface area of from about 5 to about 250 m²/g.

27. The composition of claim 26, having a packing density of from about 1.1 to about 1.7 g/cm³.

28. The composition of claim 26, wherein at least about 75 wt % of agglomerates have a mean and/or media size form about 300 to about 500 microns.

29. A device, comprising the composition of 22, wherein the composition substantially removes one or more contaminates from a fluid.

30. The device of claim 29, wherein the fluid comprises a gas or liquid.

31. The device of claim 30, wherein the fluid comprises water.

32. The device of claim 29, wherein the device is in the form of one or more of a filter, a filter bed, a filter column, a fluidized filter bed, a filter block, a filter blanket, or combination thereof.

33. The device of claim 29, wherein the one or more contaminants comprise arsenic, arsenate, and arsenite.

34. The device of claim 29, wherein the one or more contaminants comprise a biological contaminant, a microbe, a microorganism, a chemical contaminant, a chemical agent, a pharmaceutical, a person care chemical, a pesticide, an insecticide, a herbicide, a rodenticide, a fungicide, humic acid, tannic acid, an oxyanion, a dye, a dye carrier, a dye intermediate, a pigment, a colorant, an ink, a chemical contaminant, or a mixture thereof.

35. The composition of claim 22, further comprising one or more of arsenic, arsenate, arsenite, a biological contaminant, a microbe, a microorganism, a chemical contaminant, a chemical agent, a pharmaceutical, a person care chemical, a pesticide, an insecticide, a herbicide, a rodenticide, a fungicide, humic acid, tannic acid, an oxyanion, a dye, a dye carrier, a dye intermediate, a pigment, a colorant, an ink, a chemical contaminant, or a mixture thereof sorbed on the rare earth oxide-containing particles.
